(19) United States
(12) Patent Application Publication
(10) Pub. No.: US 2007/0094491 A1
(43) Pub. Date: Apr. 26, 2007

(54) Systems and methods for dynamically learning network environments to achieve adaptive security

(76) Inventors: Lawrence Chin Shiun Teo, Charlotte, NC (US); Yuliang Zheng, Charlotte, NC (US)

Correspondence Address: KILPATRICK STOCKTON LLP, 1001 WEST FOURTH STREET, WINSTON-SALEM, NC, 27101, US

(21) Appl. No.: 11/498,587

(22) Filed: Aug. 3, 2006

Related U.S. Application Data
(60) Provisional application No. 60/704,670, filed on Aug. 3, 2005.

(51) Int. Cl. H04L 9/00

(52) U.S. Cl. 713/153

(57) ABSTRACT

Systems and methods for dynamically learning network environments to achieve adaptive security are described. One described method for setting an adaptive threshold for a node includes: monitoring a data stream associated with the node to identify a characteristic of the node; monitoring an environmental factor capable of affecting the node; and determining the adaptive threshold based on at least one of the characteristic or the environmental factor. Another described method for dynamically assessing a risk associated with network traffic includes: identifying a communication directed at the node; determining a risk level associated with the communication; and comparing the risk level to the adaptive threshold.

### CROSS-REFERENCE TO RELATED APPLICATIONS

The application claims priority to U.S. Provisional Application No. 60/704,670, filed Aug. 3, 2005, entitled “Mechanisms for Dynamically Learning Network Environments to Achieve Adaptive Security,” the entirety of which is incorporated herein by reference.

### FIELD OF THE INVENTION

This invention relates to the field of network security, computer communications, and information security.

### BACKGROUND

Network administrators have access to a variety of network security devices, such as intrusion detection systems (IDSs) and firewalls. However, conventional network security devices suffer from a variety of shortcomings.

For instance, conventional network security devices typically perform only according to static preprogrammed rules. They are therefore either limited or unable to react to unknown attacks, since such attacks do not exhibit behavior that is represented in those preprogrammed rules. Also, such devices require configuration on the user's part—the user has to have a reasonable amount of knowledge about information security and networks in order to configure the device. This assumption may prove dangerous, since a user who does not specialize in the computer field may not necessarily have the sufficient amount of knowledge to configure the device. This could result in the deployment of the network security device in an insecure fashion, which in turn gives the user a false sense of security.

Conventional network security devices, such as intrusion detection system, face further challenges when implemented in large, complex networks. Such networks may receive a large number of intrusions per day, making it increasingly difficult for humans to interpret the output of the intrusion detection system. It is hard to identify which events are real intrusions and which are false positives. By the time the actual intrusions are identified, it may be too late since some damage might have already been inflicted on the compromised network. The large amount of data generated by the IDS also poses storage issues.

Further, conventional network security devices cannot be deployed into a different environment without major reconfiguration. They also require significant data storage space for storing audit data and are designed to use regular hard drives for their operations, which may affect their stability and longevity.

### SUMMARY

Embodiments of the present invention provide systems and methods for dynamically learning network environments to achieve adaptive security. One embodiment of the present invention comprises a method for setting an adaptive threshold for a node comprising: monitoring a data stream associated with the node to identify a characteristic of the node; monitoring an environmental factor capable of affecting the node; and determining the adaptive threshold based on at least one of the characteristic or the environmental factor. Another embodiment comprises a method for dynamically assessing a risk associated with network traffic comprising: identifying a communication directed at the node; determining a risk level associated with the communication; and comparing the risk level to the adaptive threshold. Yet another embodiment comprises a computer-readable medium comprising program code for implementing such methods.

These illustrative embodiments are mentioned not to limit or define the invention, but to provide examples to aid understanding thereof. Illustrative embodiments are discussed in the Detailed Description, and further description of the invention is provided there. Advantages offered by the various embodiments of the present invention may be further understood by examining this specification.

### BRIEF DESCRIPTION OF THE FIGURES

These and other features, aspects, and advantages of the present invention are better understood when the following Detailed Description is read with reference to the accompanying drawings, wherein:

FIG. 1 is a block diagram showing an illustrative environment for implementation of one embodiment of the present invention;

FIG. 2 is a block diagram illustrating an Operational Profile (“OP”) in one embodiment of the present invention;

FIG. 3 is a block diagram illustrating another Operational Profile (“OP”) in one embodiment of the present invention;

FIG. 4 is a block diagram illustrating another Operational Profile (“OP”) in one embodiment of the present invention;

FIG. 5 is a block diagram illustrating another Operational Profile (“OP”) in one embodiment of the present invention;

FIG. 6 is a block diagram illustrating the various operation modes that the Learning System may assume and the possible transitions among them in one embodiment of the present invention;

FIG. 7 is a block diagram of a hardware appliance according to one embodiment of the present invention;

FIG. 8 is a block diagram illustrating Adaptive Security System as a hardware appliance in an alternative embodiment of the present invention;

FIG. 9 is a block diagram illustrating a Reference Database in one embodiment of the present invention;

FIG. 10 is a table illustrating the Risk Level Scale in one embodiment of the present invention;

FIG. 11 is a timing diagram illustrating the process of starting and stopping the Learning System in one embodiment of the present invention;

FIG. 12 is a timing diagram illustrating the occurrence of DUMP_STATE operations in one embodiment of the present invention;

FIGS. 13, 14, 15, and 16 are graphs illustrating events in relation to time in several embodiments of the present invention;

FIG. 17 is a block diagram illustrating a configuration that allows the Adaptive Security System binary programs to be updated in one embodiment of the present invention; and

FIG. 18 is a block diagram of an adaptive security system in one embodiment of the present invention.

### DETAILED DESCRIPTION

### Introduction

Embodiments of the present invention comprise systems and methods for dynamically learning network environments to achieve adaptive security.

One embodiment of the present invention comprises an adaptive learning system that dynamically discovers various parameters in its surrounding environment, and delivers these parameters to a response system. The combination of these systems can be used to perform a beneficial task, such as providing network security for a network node. The combined system may be referred to herein as an adaptive security system.

The adaptive security system can be embodied as a hardware appliance. The hardware appliance includes firmware that implements the logic of both the learning system and the response system. The appliance includes a storage area to store reference databases and an environment profile.

The response system in such an embodiment is capable of performing some or all of the following: reading a data stream, analyzing part or all of the data stream and assigning a numeric value to the part of the data stream that it is analyzing, modifying or removing the numeric value based on a decision-making process, and comparing the numeric value to a one or more numeric thresholds. The response system may also carry out a response action when a numeric value meets or exceeds a numeric threshold.

The learning system in such an embodiment determines proper thresholds for the internal protected nodes. The learning system monitors the data streams to obtain information about the environment in which the adaptive security system is deployed. It analyzes these data streams for various parameters, which it then uses to assign reasonable thresholds to the protected nodes. While the threshold determination process can be somewhat complex, generally if the learning system determines that a node is particularly vulnerable, the learning system assigns a lower threshold to that node. In contrast, if the learning system determines that a node has a higher potential to safeguard itself against attacks (i.e., it is less vulnerable), the learning system assigns a higher threshold to that node.

A lower threshold may also signify that the node is more critical. Therefore, an attack that is directed against a node that has a lower threshold would have less chances of succeeding. That is because the threat level of that attack would have reached the protected node's threshold faster than it would have had, had the node been assigned a higher threshold. Once the threat level reaches the threshold, the response system in such an embodiment actively blocks the data stream or any data stream from the originator or both.

This introduction is given to introduce the reader to the general subject matter of the application. By no means is the invention limited to such subject matter. Illustrative embodiments are described below.

### System Architecture

Various systems in accordance with the present invention may be constructed. Such systems may include client devices, server devices, and network appliances, communicating over various networks, such as the Internet. The network may also comprise an intranet, a Local Area Network (LAN), a telephone network, or a combination of suitable networks. The devices may connect to the network through wired, wireless, or optical connections.

### Client Devices

Examples of client device are personal computers, digital assistants, personal digital assistants, cellular phones, mobile phones, smart phones, pagers, digital tablets, laptop computers, Internet appliances, and other processor-based devices. In general, a client device may be any suitable type of processor-based platform that is connected to a network and that interacts with one or more application programs.

The client device can contain a processor coupled to a computer readable medium, such as a random access or read only memory. The client device may operate on any operating system capable of supporting an application, such as a browser or browser-enabled application (e.g., Microsoft® Windows® or Linux). The client device may be, for example, a personal computer executing a browser application program such as Microsoft Corporation's Internet Explorer™, Netscape Communication Corporation's Netscape Navigator™, Mozilla Organization's Firefox, Apple Computer, Inc.'s Safari™, Opera Software's Opera Web Browser, and the open source Konqueror Browser.

### Server Devices/Network Appliances

A server device or network appliance also includes contains a processor coupled to a computer-readable medium. The memory comprises applications. A server or network appliance may comprise a combination of several software programs and/or hardware configurations. While the description below describes processes as being implemented by program code, they may be implemented as special purpose processors, or combinations of special purpose processors and program code as well.

The server devices or network appliances may also include a database server. The database server includes a database management system, such as the Oracle®, SQLServer, or MySQL relational data store management systems, which allows the database server to provide data in response to queries.

Server devices and network appliances may be implemented as a network of computer processors. Examples of server devices and network appliances are a server, mainframe computer, networked computer, router, switch, firewall, or other processor-based devices, and similar types of systems and devices. Processors used by these devices can be any of a number of computer processors, such as processors from Intel Corporation of Santa Clara, Calif. and Motorola Corporation of Schaumburg, Ill.

Such processors may include a microprocessor, an ASIC, and state machines. Such processors include, or may be in communication with computer-readable media, which stores program code or instructions that, when executed by the processor, cause the processor to perform actions. Embodiments of computer-readable media include, but are not limited to, an electronic, optical, magnetic, or other storage or transmission device capable of providing a processor, such as the processor 114 of server device 104, with computer-readable instructions. Other examples of suitable media include, but are not limited to, a floppy disk, CD-ROM, DVD, magnetic disk, memory chip, ROM, RAM, an ASIC, a configured processor, optical media, magnetic tape media, or any other suitable medium from which a computer processor can read instructions. Also, various other forms of computer-readable media may transmit or carry program code or instructions to a computer, including a router, private or public network, or other transmission device or channel, both wired and wireless. The instructions may comprise program code from any computer-programming language, including, for example, C, C++, C#, Visual Basic, Java, Python, Perl, and JavaScript.

It should be noted that the present invention may comprise systems having a different architecture than that which is shown in the Figures and described below.

### An Adaptive Security System

One embodiment of the present invention comprises an adaptive learning system that dynamically discovers various parameters in its surrounding environment, and delivers these parameters to a response system. The combination of these systems can be used to perform a beneficial task, such as providing network security.

For notational convenience, such an embodiment is referred to as the Learning System. The system, which receives the learned parameters from the Learning System, is known as the Response System. The combination of both systems is known as the Adaptive Security System.

The Learning System can be used with any Response System that is capable of communicating with the Learning System. For example, they may communicate over a common communications protocol and/or connect via a common interface.

### Response System

In one embodiment of the present invention, the Response System can be any system that is capable of performing the following five tasks:

reading a data stream,

analyzing part of the data stream or the entire data stream and assigning a numeric value to the part of or the entire data stream that it is analyzing,

modifying the numeric value or removing the numeric based on its decision-making process, and

comparing the numeric value to a set of numeric thresholds.

The Response System may carry out a response action when the numeric value is changed to the point that it meets or exceeds a numeric threshold.

In one embodiment the Response System is deployed as a device that provides security for a communications medium. In such an embodiment, the Response System is deployed between a collection of external data sources and a collection of protected internal nodes. The external data sources generate data streams that are destined to be received by one or more of the protected nodes. The protected nodes may respond to a data stream according to any predefined communication protocol that is understood by both the data source and the protected node. The protected nodes may also initiate connections to the external data sources. The role of the Response System in such an embodiment is to monitor and analyze the data streams between the internal nodes and the external data sources. If parts of the data stream are deemed to be suspicious or malicious, the Response System may actively block the initiating party from further sending any more data for a specific time period (which could be indefinite, depending on the scheme used).

For example, in one embodiment, the collection of external data sources could refer to the computer systems connected to the Internet, while the collection of internal protected nodes could refer to the machines in an internal network of an organization. The Response System could be embodied as a hardware appliance that has the ability to monitor, analyze, forward or block the network traffic between the Internet and the internal network.

The data stream between the external data sources and the internal protected nodes in such an embodiment are sent in units or fragments. For example, in the context of the Internet, the network traffic (data stream) is sent in packets. The Response System analyzes the data streams by examining the packets for anomalies, which are suspicious properties that deviate from normal behavior. Each packet is uniquely identifiable. Likewise, the originator of a specific data stream (which is basically a series of related packets) is also identifiable. If the Response System deems the packet or the data stream to be suspicious, it increases a numeric value associated with the packet or data stream. This numeric value is referred to herein as the threat level. Once the threat level has reached a certain threshold, the Response System blocks future data streams or packets that are either initiated from the suspicious originator, or exhibit suspicious properties.

### Learning System

In one embodiment of the present invention, the Learning System determines proper thresholds for the internal protected nodes. While the Learning System is described as working in conjunction with the Response System as an integrated device, i.e. the Adaptive Security System, the Learning System may be implemented as a separate, stand-alone system. The Learning System monitors the data streams to obtain information about the environment in which the Adaptive Security System is deployed. The Learning System analyzes these data streams for various parameters, which it uses to assign appropriate thresholds to the protected nodes. The threshold determination process can be somewhat complex, but, in general, if the Learning System determines that a node is particularly vulnerable, it will assign a lower threshold to that node. In contrast, if the Learning System determines that a node is less vulnerable, e.g., the node has a higher potential to safeguard itself against attacks, the Learning System assigns the node a higher threshold. A lower threshold may signify that a particular node is more critical than others. Accordingly, by setting a lower threshold to such a node, the chance of success of an attack on the node would be lower because the threat level of the attack will exceed the protected node's threshold faster than it would have had the node been assigned a higher threshold. After calculating the thresholds, the Learning System would then suggest these thresholds to the Response System. Once the threat level reaches the threshold, the Response System actively blocks the data stream or the originator or both.

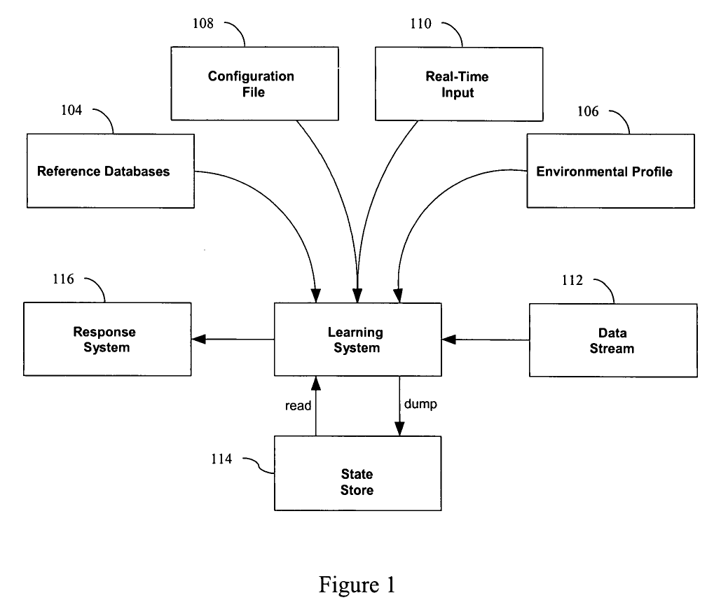

The Learning System learns about the environment in order to assign reasonable thresholds to the protected nodes. Referring now to the drawings in which like numerals indicate like elements throughout the several figures, FIG. 1 is a block diagram showing an illustrative environment for implementation of one embodiment of the present invention. FIG. 1 is a block diagram illustrating the Learning System and its interactions with various components in one embodiment of the present invention. The Learning System 102 can obtain input from one or more Reference Databases 104.

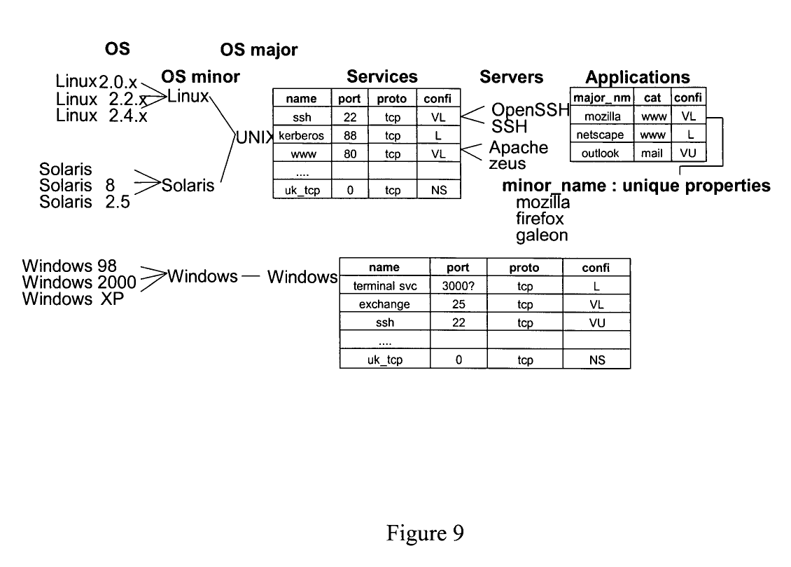

A Reference Database 104 is a knowledge base that is specific to the context in which the Adaptive Security System is deployed. For example, in the context of the Internet, it would be beneficial to learn about the operating systems, services, and applications that are part of the data stream between the external data sources and the protected nodes. A Reference Database 104 in such a context may map operating systems with their services and applications. An example of such a Reference Database is shown in FIG. 9. Reference Databases 104 can also be applied to other contexts. For example, if the Adaptive Security System is implemented as a host-based intrusion detection and response system that performs system call analysis, the Reference Databases 104 may include a specific operating system's system calls. Other examples include an insider threat management system, where the Reference Database 104 may include applications, file types, and modes of transfers, allowing the Adaptive Security System in such an embodiment to track malicious insiders who are trying to leak confidential information.

The Environment Profile 106 in the embodiment shown in FIG. 1 defines a set of parameters that help the Learning System calculate the proper thresholds for the nodes in a specific environment. For example, in an embodiment in which the Adaptive Security System is deployed in a large enterprise, important servers, such as mail servers and web servers, are assigned a high priority. In contrast, since such servers do not normally exist in a home environment, the Environment Profile 106 for a home environment would give high priority to the actual workstation(s) being used in the home network. Other environments can be envisioned; for example, the priorities change again for a business traveler with an Adaptive Security System device deployed between the laptop and the Internet. In some embodiments, for environments that are not pre-defined, a generic Environment Profile 106 can be used.

The embodiment shown in FIG. 1 also comprises a Configuration File 108. The Configuration File 108 allows the user of the Adaptive Security System to specify configuration parameters for the Adaptive Security System.

The Learning System shown also receives Real Time Input 110. Real Time Input 110 allows dynamic real time input to the Adaptive Security System that influences the Learning System's calculation of the threshold. For example, if a worm is spreading across a large part of the Internet, this event would be discovered by Internet traffic monitoring organizations. These organizations would raise their threat level during such events. These threat levels could be utilized as Real Time Input 110 for the Learning System 102. The Learning System 102 then uses the Real Time Input 110 to calculate its thresholds. For instance, in a case where worm activity has been detected, the Internet threat level would be high; thus, the node thresholds would be lowered since worm attacks are more likely. In contrast to the Reference Databases 104 and the Environment Profile 106, which are somewhat static, the Real Time Input 110, as the name suggests, is real-time in nature.

In the embodiment shown in FIG. 1, the Learning System 102 also has access to the data stream 112. The Learning System 102 analyzes the data stream 112 and uses the parameters from the Reference Databases 104, Configuration File 108, Real Time Input 1 10, and Environment Profile 106 to calculate thresholds for the nodes.

In the embodiment shown, while the Learning System 102 is learning its surrounding environments, it may record the results in a state store 114 periodically. This writing process may be referred to as “dumping state.” The state store 114 attempts to capture as much information about the historical series of events in the Adaptive Security System's environment while maintaining minimal storage costs. In one embodiment, the latest state contains a record of the latest information learned about the network. This is referred to as “just-in-time state updates.”

### Illustrative Embodiments

In embodiments of the present invention, the Adaptive Security System may be embodied as a hardware appliance. The hardware appliance is loaded with firmware that implements the logic of both the Learning System 102 and the Response System 116. The appliance also includes a storage area to store the Reference Databases 104 and Environment Profile 106. This storage area that hosts the Reference Databases 104 and Environment Profile 106, as well as the Learning System 102 and Response System 116, in such an embodiment are writable so that they can be updated.

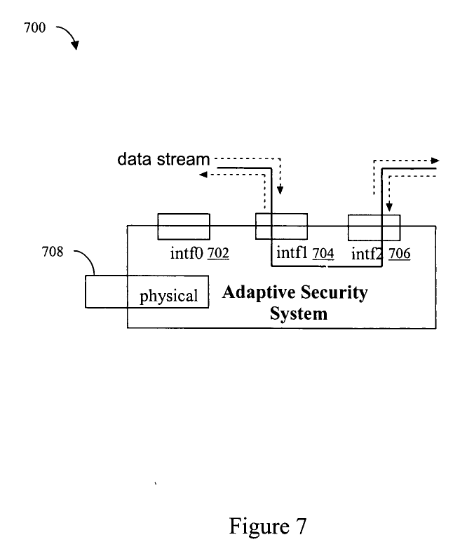

FIG. 7 is a block diagram of a hardware appliance according to one embodiment of the present invention. The appliance shown 700 comprises three input/output interfaces that could be used to communicate with the external environment. In FIG. 7, two of these input/output interfaces (intf1 704 and intf2 706) are used to route the data stream in a symmetric (full duplex) mode. The third interface may be used for management and administration (intf0 702). An additional physical interface 708 may be used when communication with the input/output interfaces is either inconvenient or impossible. For instance, the physical interface 708 could be used to update the Reference Databases and Environment Profile if the Adaptive Security System device has no link to the external Internet to accomplish these updates. One example of a physical interface 708 is a USB port.

While the embodiment shown in FIG. 7 includes three input/output interfaces; an appliance according to an embodiment of the present invention does not require three interfaces. The number of input/output interfaces depends on the application and environment in which the Adaptive Security System is used. However, an appliance according to an embodiment of the present invention will generally comprise at least one input/output interface to access the data stream.

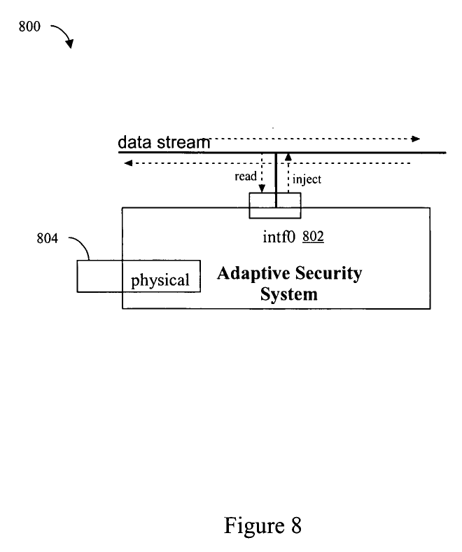

FIG. 8 is a block diagram illustrating Adaptive Security System as a hardware appliance in an alternative embodiment of the present invention. The Adaptive Security System 800 shown comprises only one input/output interface 802. In the embodiment shown, the Adaptive Security System 800 is able to read the data stream via the input/output interface 802. It is also capable of injecting new information into the data stream. The embodiment shown also includes a physical interface 804.

Other embodiments may also be implemented according to the present invention. For instance, one embodiment comprises a hardware appliance having more than three input/output interfaces, which may be used for more demanding applications.

Also, different variants of a hardware appliance may be customized for specific applications. For instance, for a home or SOHO (“Small Office/Home Office”) market, a low-powered hardware appliance may be sufficient. Therefore, the Adaptive Security System could be embodied as a small hardware appliance with CompactFlash as data storage. For the enterprise environment, however, a higher-powered hardware appliance may be desirable. In such environments, a suitable variant of the Adaptive Security System hardware appliance could be a rackmount server with a large data storage area, additional memory, and greater processing power.

### Operational Profiles

Embodiments of an Adaptive Security System may be deployed in a variety of configurations. These configurations may be referred to as Operational Profiles (“Ops”). These operational profiles influence how the Adaptive Security System learns its environment. Use of OP's helps to allow the Adaptive Security System to be seamlessly integrated into different environments so that the device should is usable with minimal or no configuration on the user's part. In evaluating data streams, the Learning System determines which data stream connections originate from external data sources and which are initiated by the internal protected nodes. In the context of the Internet, the Adaptive Security System studies the IP addresses that it encounters and determines which are from the Internet (external IP addresses) and which belong to the internal network. There are two broad strategies to accomplish this: the first is to study the pattern of the IP addresses that the Adaptive Security System encounters, and the second is to examine the data streams at the input/output interfaces.

Operational Profiles help to accomplish the first strategy. The description of the following Operational Profiles assume that the Adaptive Security System is deployed in the Internet and networking domain.

### Operational Profile 1: Inter-Department

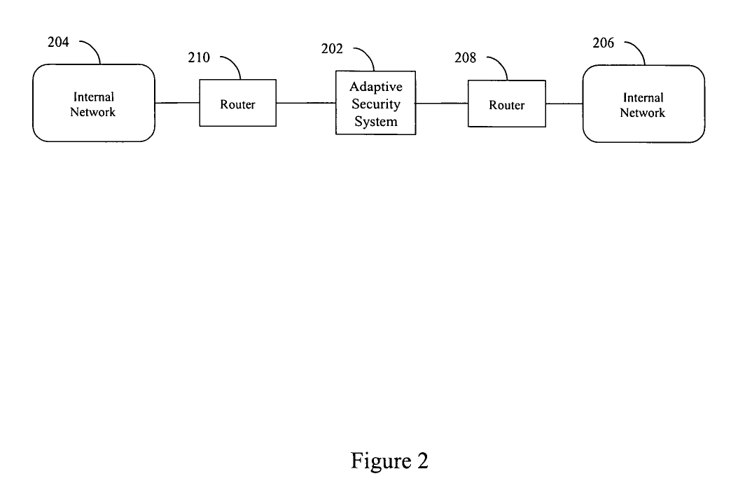

FIG. 2 is a block diagram illustrating an Operational Profile (“OP”) in one embodiment of the present invention. In OP1, the Adaptive Security System 202 is deployed between two internal networks (e.g., between two departments) 204, 206 as an OSI layer 2 bridge. Each internal network is connected to the Adaptive Security System 202 by a router 208, 210. Since the IP addresses belonging to each internal network belong to the same subnet, they tend to repeat themselves.

### Operational Profile 2: Enterprise

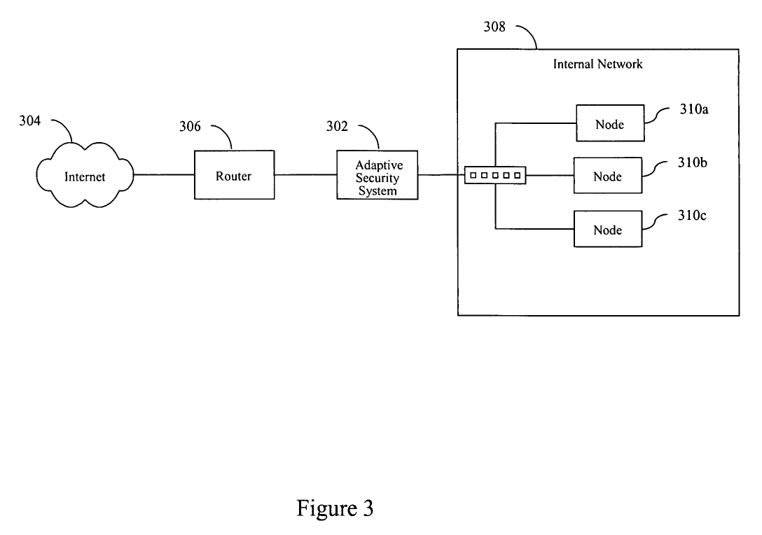

FIG. 3 is a block diagram illustrating another Operational Profile (“OP”) in one embodiment of the present invention. In this operational profile, the Adaptive Security System 302 is deployed between the Internet 304 via a router 306 and an internal network 308 as an OSI layer 2 bridge. The internal network 308 comprises a plurality of nodes 310a-c. The IP addresses of the nodes 310a-c in the internal network 308 are encountered often, while the IP addresses on the Internet would appear more “random.”

### Operational Profile 3: Single Node

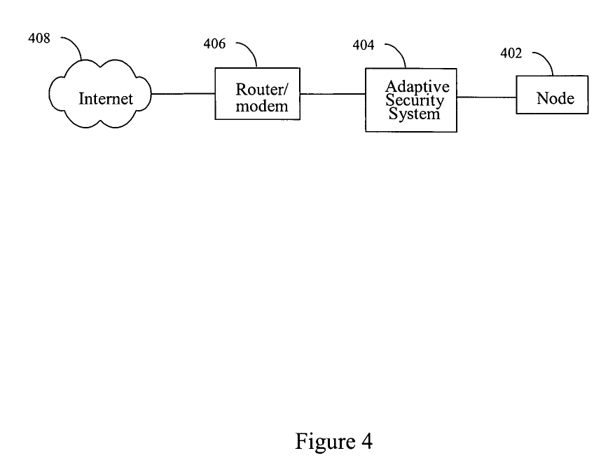

FIG. 4 is a block diagram illustrating another Operational Profile (“OP”) in one embodiment of the present invention. OP3 represents a typical operational profile for a home user with just one workstation or a business traveler with a laptop (node 402). The Adaptive Security System 404 is in communication with the node 402 and acting as an OSI layer 2 bridge. The Adaptive Security System 404 is also in communication with the Internet 406 via a router 408. In this case, only the IP address of the node 402 would appear consistently in the data streams received by the Adaptive Security System 404.

### Operational Profile 4: Router Configuration

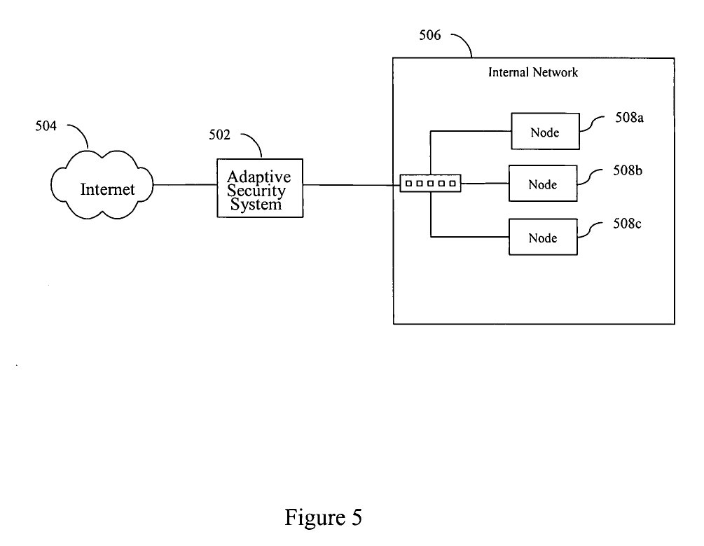

FIG. 5 is a block diagram illustrating another Operational Profile (“OP”) in one embodiment of the present invention. In the previous three operational profiles, the Adaptive Security System is implemented as a Layer 2 bridge. In OP4, the Adaptive Security System 502 is implemented as a router. The Adaptive Security System 503 is in communication with the Internet 504. The Adaptive Security System 502 is also in communication with an internal network 506. The internal network 506 comprises a plurality of nodes 508a-c.

In such an embodiment, the Adaptive Security System is able to receive all data streams and determine which IP addresses belong to which category, internal or external. However, the in such an embodiment, user configuration is required to set up a router.

Other factors may influence the Learning System's algorithms in these Operational Profiles as well. One such factor would be whether IPv4 or IPv6 is used. Another factor is the way in which IP addresses are assigned in each Operational Profile, e.g., DHCP and static IP address assignments. IPv6's stateless auto-configuration mechanisms, which rely on the MAC address of the Network Interface Card (NIC), may also affect the Operational Profile. These factors are referred to as sub-configurations. The following table lists some possible sub-configurations:

Identifying Address via Input/Output Interfaces

| | DHCP | Static IPs | Ipv6 autoconfig | DHCPv6 |
|---|---|---|---|---|
| IPv4 only | Yes | Yes | | |
| IPv4 and IPv6 | Yes | Yes | Yes | Yes |
| IPv6 only | | Yes | Yes | Yes |

As mentioned in the previous section, one embodiment of the present invention adheres to two broad strategies by which to identify which IP addresses belong to the external data sources or the internal protected nodes. The second strategy of these to strategies is to identify the origin of the addresses by examining which input/output interface the data stream's originator first appeared. While this approach may be more accurate than the previous one, it may also incur a performance penalty relative to the first once since observing and comparing data at the level of the input/output interfaces requires computational cycles.

The following discussion refers again to Figure & and requires several assumptions. First, the input/output interface intf1 704 is connected to the external Internet (not shown). Second, input/output interface intf2 706 is connected to an internal network. Accordingly, intf1 704 is referred to as the external interface (ext_intf), and intf2 706 is referred to as the internal interface (int_intf). The Learning System observes both interfaces by running a packet capture facility.

The basic operation in this strategy is to examine the characteristics of the data stream when it appears in both the external and internal interfaces. Each chunk (packet) of the data stream (network traffic) includes have certain fields, such as the timestamp, sequence number, source IP address or other identifier, destination IP address or other identifier, and so forth. The timestamp would be especially relevant in this case. This is because, if a particular packet originates from the Internet, its timestamp on the external interface would show an earlier time compared to its timestamp on the internal interface. Based on these characteristics, we can make the following observation:

If a packet is incoming (e.g., a packet from the Internet), time(ext_intf)<time(int_intf). Likewise, if the packet is outgoing (e.g., a packet from the internal network), time(ext_intf)>time(int_intf). Typically, the differences in the time between these interfaces are very small, so the measurement is performed in milliseconds.

### Illustrative Embodiment of Identifying the Origin

The tables below illustrate an example of the use of this strategy to determine the origin of a packet. Assume the following packets were observed on the external interface:

Packets seen on ext_intf

| Time | Source IP + Port | | Destination IP + Port | Sequence # | Ref # |
|---|---|---|---|---|---|
| 18:34:32.884453 | 192.168.0.4.3416 | > | 10.20.30.40 | 2804503991 | 1 |
| 18:34:32.883958 | 10.20.30.40 | > | 192.168.0.4.3416 | 3935917580 | 2 |

And the following packets were observed on the internal interface:

Packets seen on int_intf

| | | | Destination | | |
|---|---|---|---|---|---|
| Time | Source IP+Port | | IP+Port | Sequence # | Ref # |
| 18:34:32.884324 | 192.168.0.4.3416 | > | 10.20.30.40 | 2804503991 | 3 |
| 18:34:32.904308 | 10.20.30.40 | > | 192.168.0.4.3416 | 3935917580 | 4 |

(Note:
in the tables above, Ref # is added for reference, and the other fields are captured from the data stream.

From the tables, the Learning System observes that the sequence number of packets #1 and #3 is 2804503991, so they are essentially the same packet. However they were observed on different interfaces. The timestamp of the two packets is different. The timestamp of packet #3 is earlier than that of packet #1. Thus, the Learning System determines that the source IP address (192.168.0.4) belongs to the internal network.

#1=#3: same packet, src_ip=192.168.0.4, seq#=2804503991

time(ext_intf)>time(int_intf): therefore, src_ip (192.168.0.4) is internal

Similarly, the Learning System determines that packets #2 and #4 share the same sequence number, and therefore they are actually the same packet. The timestamp of packet #2 is earlier than the timestamp of packet #4. Therefore, the IP address 10.20.30.40 belongs to the external Internet.

#2=#4: same packet, src_ip=10.20.30.40, seq#=3935917580

time(ext_intf)<time(int_intf): therefore, src_ip (10.20.30.40) is external

In the embodiment above, only the sequence numbers of the packets are matched in order to determine that two packet instances observed in both interfaces are actually the same packet. In the one embodiment, the Learning System also matches the source IP address, source port, destination IP address, and destination port.

Depending on the actual embodiment of the Adaptive Security System, other methods may be used to identify which IP addresses belong to the external data sources or the internal protected nodes. For example, this information can be obtained via operating system user-level or kernel-level facilities, system calls, routing tables, and other similar techniques.

### Fragmentation and Normalization

In a real world network, the Learning System and the Response System in an embodiment of the present invention need to cooperate with each other to enable IP addresses to be accurately assigned to the correct pool of addresses. One reason for this is that real world network traffic may be subject to fragmentation. Fragmentation can be either unintentional or intentional. Unintentional fragmentation occurs when a packet is too large for a particular physical network on its route to the destination, and therefore that packet has to be divided further into smaller units or fragments. This is a normal behavior. Intentional fragmentation occurs when a packet is split into separate fragments intentionally. For instance, an attacker might intentionally fragment a data stream into more packets than necessary in order to evade intrusion detection systems.

Since defragmented data streams, which may be referred to as normalized data streams are easier to analyze, one embodiment of the present invention comprises a normalization component to normalize data streams. In some embodiments, the normalization component is implemented natively in the Response System. In other embodiments, open source software is utilized.

In one embodiment in which a normalization component is utilized, the raw fragmented data stream appears on the external interface. The Response System then normalizes the data so that a normalized data stream appears on the internal interface. In such an embodiment, the Response System observes data streams on the internal interface only.

Such an embodiment provides challenges to the Learning System. Since fragmented packets might appear on the external interface, and corresponding normalized data appears on the internal interface, it may be difficult to match the packet instances to determine the timestamps. In one embodiment, the Learning System observes a specific subset of packets. For instance, in one embodiment in which a TCP connection is utilized, the Learning System observes only packets with the SYN, FIN, and ACK flags turned on. Such packets are generally far too small to fragment (in most cases, the data payload for these packets is 0 bytes). Such an embodiment provides performance advantages. The Learning System only examines a small set of packets to determine where an IP address belongs, thus reducing the amount of computational cycles required to perform this task.

One embodiment of the present invention also observes RST packets. However, while SYN, FIN, and ACK packets are good candidates for this observation, RST packets may not be so, since it is possible that the Response System is intentionally crafting RST packets to actively terminate connections for which threat levels have exceeded their thresholds.

### Operation Modes

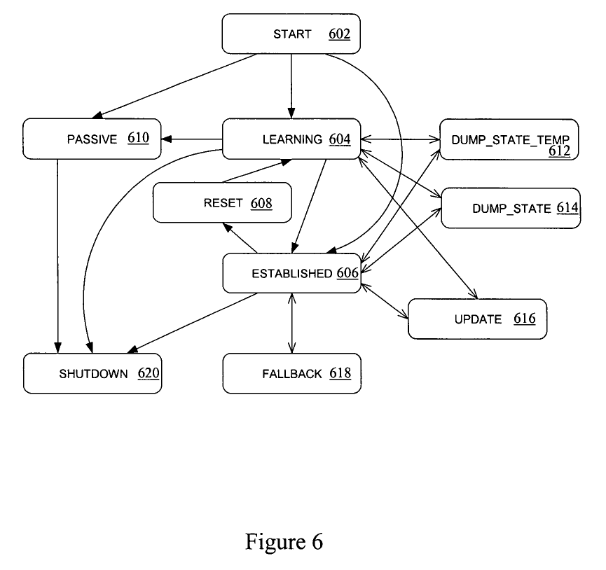

In order to learn its surrounding environment, embodiments of the Learning System can operate in different modes. FIG. 6 is a block diagram illustrating the various operation modes that the Learning System may assume and the possible transitions among them in one embodiment of the present invention. Operation modes that may be used in an embodiment of the present invention are explained briefly below, and then a more detailed discussion of each state is presented.

### Brief Discussion of the Operation Modes

START 602: The START mode initializes the Learning System when it is first started.

LEARNING 604: The Learning System enters this mode when it is dynamically discovering parameters within the system, but is not confident that sufficient information about the environment has been collected.

ESTABLISHED 606: In this mode, the Learning System is confident that it has collected enough information to have an accurate picture of its environment. Note that the Learning System may still continue monitoring its environment for new information.

RESET 608: When this mode is invoked, the Learning System returns from the ESTABLISHED mode to the LEARNING mode. This mode could be invoked, for example, when the Learning System encounters radically new information in the data stream, thus reducing its confidence that sufficient information has been gathered.

PASSIVE 610: This mode causes the Learning System enter a passive monitoring mode, where the Learning System simply monitors the data stream and reports on its activities.

DUMP_STATE_TEMP 612: The Learning System enters this mode when it is writing its variables (what it has learned so far) into a temporary state. This may happen, for example, every two hours.

DUMP_STATE 614: The difference between this mode and the previous DUMP_STATE_TEMP mode is that DUMP_STATE writes the variables into “permanent” state. In this context, permanent means “long-term”. This mode could be invoked, for example, at midnight every day. The reason why there are two modes for dumping state in the described embodiment is to achieve a balance between the operational costs of dumping the state and the persistence of the state. DUMP_STATE_TEMP is meant for dumping state with very low operational cost, but the state may not persist (e.g., it may disappear when the Learning System is restarted). DUMP_STATE dumps the state into persistent storage, but the computational costs for doing so are higher.

UPDATE 616: This operation mode is used when updating a number of components: the Learning System, the Response System, and reference databases.

FALLBACK 618: This mode is invoked when the Learning System detects that its state has reached a point where it is unable to be updated anymore (for example, if the storage area for storing the state has run out). The Learning System would then invoke a fallback procedure to enable the state to be updated again.

SHUTDOWN 620: The Learning System enters the SHUTDOWN mode when it is in the process of halting itself.

### Detailed Discussion of the Operation Modes

The following provides a detailed discussion of the Operation Modes implemented in the Learning System in one embodiment of the present invention.

START: The Learning System enters the START mode when it is first started. In this mode, the variables and runtime configuration parameters of the Learning System are initialized. The Learning System first checks if any state exists. If the state does not exist, then the Learning System has been started for the first time. The Learning System creates the state and initializes the variables in the state. If the state already exists, the Learning System reads variables in the state into its memory.

Once the initialization process has been completed, the Learning System can transition into one of three operation modes: LEARNING, ESTABLISHED, or PASSIVE. The Learning System determines whether it has sufficiently learned its environment. If it has not, it will switch to the LEARNING operation mode. Otherwise, it enters the ESTABLISHED mode.

Whether the Learning System has sufficiently learned its environment is determined by the elapsed time and amount of data stream activity that it has monitored. By the time the environment has been learned, the Learning System would have compiled a list of addresses and would know which belong to an external data source, and which belong to the protected internal nodes.

The PASSIVE operation mode is entered when the administrator configures the Learning System to do passive monitoring. In some embodiments, the PASSIVE mode operation may be entered automatically.

LEARNING: The LEARNING mode lets the Learning System learn its surrounding environment. A variety of learning schemes could be used in embodiments of the present invention. Monitoring of the data stream is done to collect information. The two main objectives of the LEARNING mode are to: (1) collect information from the data stream, and (2) assign thresholds to the nodes. The information that is collected may include, by way of example, the following:

(a) the set of node addresses participating as external data sources;

(b) the set of node addresses participating as internal protected nodes; and

(c) the information described in the section below entitled Multiple Input Sources.

Various learning schemes may be used to determine (a) and (b). For example, one scheme would be to listen on two input/output interfaces and monitor the data stream according to the strategy outlined in the section entitled “Identifying Address via Input/Output Interfaces. As for (c), only one input/output interface needs to be monitored to collect that type of information.

In one embodiment of the present invention, thresholds are assigned to nodes based on how confident the Learning System is about the collected information. This may be done by monitoring the frequency of specific instances of the collected information in relation to elapsed time. Confidence levels are mapped to these instances of collected information. These confidence levels can be incremented or decremented depending on various schemes. In one embodiment, the Learning System continues incrementing the confidence level of a specific instance if it keeps appearing in the data stream. Therefore, the more frequent that instance is, the higher its confidence level will be. The higher the confidence level of that instance is, the more confident the Learning System is about that instance.

These confident levels may be interpreted by the Learning System as being estimates about how “true” the information instance is, until they meet a certain confidence threshold. If the confidence level of a particular instance meets or exceeds its confidence threshold during the learning process, the Learning System would have “absolute” confidence in that instance as being the “truth.” These confidence thresholds are defined in the Environment Profile, which is described below.

Once an overall confidence level is achieved, the Learning System in one embodiment of the present invention can enter the ESTABLISHED operation mode. Various schemes could be used to determine when the Learning System is confident enough about its surrounding environment. For instance, in one embodiment, the Learning System utilizes a scheme in which the Learning System is confident enough to enter ESTABLISHED mode when 80% of all collected instances have confidence levels that have exceeded their confidence thresholds. Priority in such an embodiment may be given to the first two sets of information mentioned above: the set of node addresses participating as external data sources, and the set of node addresses participating as internal protected nodes.

ESTABLISHED: ESTABLISHED mode means that the Learning System has sufficiently learned about its surrounding environment. In this operation mode, the Learning System will inform the Response System about the node thresholds that it has assigned to the nodes during the LEARNING mode. In this mode, the Learning System only needs to listen on one input/output interface, since the external data sources and the internal protected nodes have already been established. Listening on just one input/output interface instead of two also reduces computational costs associated with monitoring the data stream.

RESET: In one embodiment, the RESET operation mode can only be invoked when the Learning System is currently in ESTABLISHED mode. In other embodiments, the RESET mode may be invoked at other times. The RESET mode is a transition mode that clears the confidence levels of all information instances in the state and returns AEF back to LEARNING mode.

The RESET mode may be either deliberately entered by the administrator or may invoked automatically by the Learning System. An administrator utilizing an embodiment of the present invention might want to invoke the RESET mode for a number of reasons: for instance, the administrator may be installing a new server and require that the Learning System explicitly relearn its environment with the new server in place. Or the administrator may be deploying the Adaptive Security System in a totally new environment, where the state of the Adaptive Security System collected so far is no longer relevant.

The RESET mode could also be automatically invoked by the Learning System. This could be done, for instance, when the overall confidence level drops (e.g., if the percentage of information instances that have exceeded their confidence thresholds is no longer 80%).

For example, in one embodiment of the present invention, the Learning System learns that it is monitoring internal protected nodes with IP addresses within a 192.168.0.0/24 subnet. The Adaptive Security System is then suddenly deployed in a new environment, which uses addresses from a 172.16.0.0/16 subnet. Thus, when an IP address from the new 172.16.0.0/16 address is suddenly seen on the int_intf interface, which is totally alien from the 192.168.0.0/24 subnet, the Learning System would enter the RESET mode to revert back to LEARNING mode. Other embodiments of the current invention may invoke different default behaviors and other schemes could be used to determine when the Learning System automatically invokes the RESET mode.

PASSIVE: The PASSIVE mode is used for passive monitoring of the data stream only. This mode is primarily used for collecting statistical information for testing the Adaptive Security System. The PASSIVE mode may apply to both the Learning System and the Response System. In such an embodiment, both systems report their activities but do not actually alter the data stream. This mode may affect the Response System more than the Learning System, since the Response System would not actually block suspicious traffic, but would just keep a log of them. When the PASSIVE mode is invoked, both the Learning System and Response System will be set to the PASSIVE mode. In one embodiment, the administrator manually invokes the PASSIVE mode. In other embodiments, the PASSIVE mode may be invoked automatically.

DUMP_STATE_TEMP: The collected information, confidence levels, and assigned node thresholds are all stored as state by the Learning System. The state is maintained in memory until it is written to the storage medium or file system periodically. The act of writing state onto a file system is known as “dumping state.” State is written to the file system so that memory resources that were previously used by the Learning System to keep state can be used for other purposes.

In one embodiment, the DUMP_STATE_TEMP operation mode is used to dump state into a temporary non-persistent file system (the state would no longer be available when the Adaptive Security System hardware appliance is restarted). Although the state is non-persistent, there are a number of advantages for dumping state this way. The computational cost for doing this is low, and the speed is fast. It does not do much “damage” (wear and tear) to the storage medium. As such, it can be done very frequently. The actual frequency for invoking DUMP_STATE_TEMP can be decided based on the administrator's preferences or derived from a system default value (say, every two hours).

DUMP_STATE: The DUMP_STATE operation mode may be thought of as the opposite of the DUMP_STATE_TEMP mode. Unlike the DUMP_STATE_TEMP mode, the DUMP_STATE mode is meant to write state either permanently or for long-term storage purposes. Thus, the state will still be available even when the Adaptive Security System hardware appliance is restarted. However, this operation mode does incur higher costs—it is higher in terms of computational costs, slower in terms of speed, and does more wear and tear to the storage medium compared to DUMP_STATE_TEMP.

For example, in one embodiment in which the Learning System is embodied in a hardware appliance, the storage medium may wear out after many writes, such as a hardware appliance utilizing CompactFlash cards. CompactFlash cards could potentially be worn out after many writes, such as 100,000 times. To prevent this from happening, two file systems may be used by one embodiment of the present invention:

Filesystem 1: a read-only file system that uses the entire storage space of the CompactFlash card; and

Filesystem 2: a read-write file system that is based on unused memory.

The Learning System and Response System, along with the permanent state information, could be stored on Filesystem 1. Note that while Filesystem 1 is considered “read-only,” it can be reconfigured to be read-write for a very short period of time (say, half a minute), before being reconfigured as read-only again. In other words, Filesystem 1 is read-only most of the time, but it can be read-write some of the time.

The temporary state can be stored on Filesystem 2. DUMP_STATE_TEMP will write its state to Filesystem 2, and the costs and speed for doing so are negligible (a memory-based file system supports very fast reads and writes). However, the drawback is that the state is not persistent.

A DUMP_STATE operation would transfer the state from Filesystem 2 to Filesystem 1. During this process, Filesystem 1 is reconfigured to be read-write for a short period of time to enable the temporary state from Filesystem 2 to be written to Filesystem 1. After the state has been written to Filesystem 1, and validated to be written correctly, Filesystem 1 is reconfigured to be read-only again.

Due to the type and number of operations in a DUMP_STATE operation, the computational costs would be higher and the speed of writing the permanent state would be slower. In addition, since it actually writes to the storage space of the CompactFlash card (or other similar storage medium), it would wear the storage medium slightly on every write. Thus, the DUMP_STATE operation should not be performed as frequently as DUMP_STATE_TEMP; a possible scheme would be to have the DUMP_STATE operation done at midnight everyday, or during a non-peak period.

The following table summarizes the differences between DUMP_STATE_TEMP and DUMP_STATE.

Differences between DUMP_STATE_TEMP and DUMP_STATE

| | | Computa- | | Storage | |
|---|---|---|---|---|---|
| | | tional | | Media | |
| Operation Mode | Persistence | Cost | Speed | Cost | Frequency |
| DUMP_STATE_TEMP | Non-persistent | Low | Fast | Low | High |
| | (Temporary) | | | | |
| DUMP_STATE | Persistent | High | Slow | High | Low |
| | (Permanent/Long | | | | |
| | term) | | | | |

Table Legend:

Computational Cost: Computational cost of storing the state.

Speed: Speed of storing the state.

Storage Media Cost: Wear and tear done to the storage medium.

Frequency: The recommended frequency for performing this dump operation.

UPDATE: The UPDATE mode is used for updating the components of the Adaptive Security System, including the Learning System program, Response System program, and reference databases. In the update process, the Adaptive Security System components are replaced with newer versions of themselves. Updates are used to fix bugs, introduce newer and advanced algorithms to the components, or, in the case of the reference database, introduce updated reference databases that are more relevant to the current environment.

In one embodiment, before the UPDATE mode is invoked, a DUMP_STATE operation is done to make the state permanent during the update, so that no state changes are lost during an update. This also ensures that the updated version of the Learning System would be able to use the most up-to-date state.

When the UPDATE operation mode is entered, the Learning System proceeds to update itself using the procedures described in the “Updating the Learning System” section below. After the updating process is complete, validation is done by performing sanity checks on the updated components and ensuring that the current state has no version incompatibilities with the new version, of the components. Following this, the UPDATE operation mode is returned to the previous mode, which is either LEARNING or ESTABLISHED.

FALLBACK: As a finite state machine, the state of the Adaptive Security System may evolve to the point where it is unable to evolve anymore. An example of such a scenario would be when the confidence levels and threat levels have all exceeded their thresholds, or have reached their respective maximum values (the end of the confidence/threat level scale).

The FALLBACK mode is used to let the current confidence levels drop back to lower levels. One reason we want to do this is to prevent confidence levels from reaching the end of the confidence level scale, which far exceeds the confidence thresholds. When this mode is invoked, all the confidence levels, or only specific confidence levels (depending on the fallback scheme being used) are reduced by a certain percentage or value, which may or may not be calculated in relation to the confidence threshold. Apart from the fallback scheme, the decremented values also depend on the environment profile that is currently being used in that session.

The FALLBACK mode can also be used for the Response System. When used for the Response System, the threat levels are treated analogously like confidence levels.

SHUTDOWN: The SHUTDOWN mode is invoked when the Learning System is shutting down. Shutting down the Learning System might be used by the administrator to halt the system (via a command which is issued using hardware or software). Alternatively, the Adaptive Security System could shut itself down due to a detected hardware fault, an unexpected error or condition, a lack of power because of a blackout, or a need for a scheduled/unscheduled physical maintenance by the administrator.

During SHUTDOWN mode, the state is dumped into Filesystem 1 using a DUMP_STATE operation. Other information such as a snapshot of the current system state, debug information, or a log of the latest activities on the system may also be recorded on permanent storage for diagnostic purposes.

### Multiple Input Sources

This section describes the information that may be collected by one embodiment of the present invention during the LEARNING operation mode. As mentioned earlier, one of the objectives of the LEARNING operation mode is to assign thresholds to the nodes. To do this, the Learning System collects information that it can use to calculate node thresholds. This information can be collected from multiple input sources, and depending on the application of the Adaptive Security System, these sources can vary. These sources are referred to as Threshold Determination Factors, or TDFs. These Threshold Determination Factors are monitored and collected from the data stream.

In some embodiments of the present invention, these Threshold Determination Factors are compared with the relevant Reference Databases, and then assigned to the modifiers in the Environment Profile, to calculate node thresholds.

In one embodiment of the present invention, three types of Threshold Determination Factors are utilized: Basic TDFs, Composite TDFs, and Management TDFs.

### Basic Threshold Determination Factors

Basic Threshold Determination Factors can be read directly from the data stream. For example, in one embodiment, the Learning System is monitoring a computer network running TCP/IP. Different operating systems may be running on both the external and internal nodes. When initiating a TCP connection, each operating system exhibits certain characteristics on the first packet of network traffic that they generate (these characteristics may be present on every packet, but the discussion is limited to the first packet). These characteristics are unique enough for the Learning System to identify the operating system that initiated the connection. These characteristics are referred to collectively as an operating system fingerprint, or OS fingerprint. Therefore, if a Reference Database of OS fingerprints is available, the Learning System is able to identify the operating system of the initiating node of any TCP connection by simply monitoring the data stream and comparing the OS fingerprint to a Reference Database of OS footprints. Thus, the operating system in such an embodiment is used as a Basic Threshold Determination Factor.

One objective for using the Basic Threshold Determination Factor is to determine the risk associated with the Basic TDF. This risk, which may be measured as a risk level, is then used to calculate the threshold for the node. In the example above on using the operating system as a Basic TDF, depending on the security track record of that operating system and its vendor, a certain risk level can be assigned to that operating system. This risk level may be in turn used to calculate the node threshold.

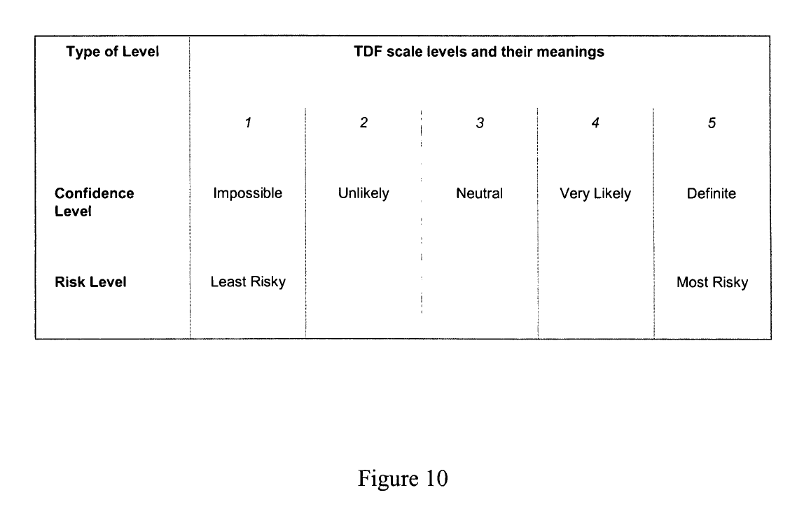

For instance, in one embodiment, Operating System A has had more security vulnerabilities than Operating System B in the past five years. Therefore, Operating System A is more risky than Operating System B, and should be assigned a higher risk level. This risk level will affect the calculation of the node threshold—the higher the risk level, the lower the node threshold (the node will be less tolerant to suspicious traffic). FIG. 10 is a table illustrating the Risk Level Scale in one embodiment of the present invention. In the scale shown, 1 represents the least risk, while 5 represents the most risk.

In one embodiment, a numeric modifier defined in the Environment Profile determines the amount that the node threshold is lowered. In such an embodiment, the Environment Profile includes a record for the Operating System Basic TDF, and modifiers for each risk level in the Risk Level Scale.

For example, in one embodiment, Node N is running Operating System A. The current Environment Profile defines the following values:

| | |
|---|---|
| Initial Threshold for New Nodes: | 10 |
| Risk Level of Operating System A: | 4 |
| Risk Level of Operating System B: | 2 |
| Threshold Modifier for Risk Level 1: | 0 |
| Threshold Modifier for Risk Level 2: | −0.2 |
| Threshold Modifier for Risk Level 3: | −0.3 |
| Threshold Modifier for Risk Level 4: | −0.4 |
| Threshold Modifier for Risk Level 5: | −0.5 |

Thus, when the Learning System encounters Node N, it performs the following tasks:

Node N is a new node, therefore assign it the Initial Threshold=10;

Node N's threshold=10;

Identify the operating system of Node N. The operating system is A;

Look up the Risk Level of A. The Risk Level of A is 4;

Look up the Threshold Modifier of Risk Level 4. The Threshold Modifier is −0.4; and

Calculate Node N's threshold using this modifier.

Node N's threshold=10−0.4=9.6

In the embodiment described, Node N's final threshold is determined to be 9.6. Note that Node N's threshold has been reduced from its original threshold of 10, since it is using a risky operating system.

In another embodiment of the present invention, Node Z uses operating system B. The Learning System performs the same tasks as are described above:

Node Z is a new node, therefore assign it the Initial Threshold=10;

Node Z's threshold=10;

Identify the operating system of Node Z. The operating system is B;

Look up the Risk Level of B. The Risk Level of B is 2;

Look up the Threshold Modifier of Risk Level 2. The Threshold Modifier is −0.2; and

Calculate Node Z's threshold using this modifier.

Node Z's threshold=10−0.2=9.8

Node Z's final threshold is calculated to be 9.8. Since Node Z's operating system is less risky than Node N's operating system, Node Z's threshold is higher than Node N's. This means that Node Z is more tolerant to attacks than Node N.

The following list includes Basic TDFs that may be utilized by embodiments of the present invention. For each TDF, how the risk affects the node threshold and what the rationale behind that scheme is are described. The list is not exhaustive. Possible Basic Threshold Determination Factors include, but are not limited to:

Operating System.

Threshold determination scheme: The worse the security track record (e.g. number of security vulnerabilities in past x years) is, the lower the threshold would be.

Rationale: The more vulnerabilities the operating system has, the more likely attackers are able to find ways to break in.

Operating System Version.

Threshold determination scheme: The older the operating system version is, the lower the threshold would be.

Rationale: If an operating system version is old, it could mean two things: (1) this operating system may have exploitable bugs that have been fixed by newer versions of the operating system; or (2) this could be an old, neglected, and possibly unpatched machine with many security holes still open.

Number of Services Running on Node.

Threshold determination scheme: The more services that are running on the node, the lower the threshold would be.

Rationale: More running services mean more entry points for a potential attacker.

Types of Services Running on Node.

Threshold determination scheme: If the node is running services such as Telnet or FTP, the lower the threshold would be. On the other hand, if SSH is being run, the threshold would not be reduced with the same amount as Telnet or FTP.

Rationale: Services such as Telnet and FTP transmit their communication in plaintext, thus making them susceptible to eavesdropping. An attacker might be able to break into the node by using a sniffed password.

Applications.

Threshold determination scheme: This is similar to the criteria used for operating systems. The worse the security track record is, the lower the threshold would be.

Rationale: Worse security track record means possibly more existing security holes.

Application Version.

Threshold determination scheme: The older the version is, the lower the threshold would be.

Rationale: The older the application version is, the more likely that there will be exploitable bugs.

Basic TDFs are also used by the Response System to respond to attacks. For instance, suppose the Adaptive Security System is monitoring mail traffic. If a node is known to be running Linux, and an email attachment comprising a Windows .exe file is sent to it, this could mean something suspicious—the Response System can then take appropriate action to block the mail from going through.

### Composite Threshold Determination Factors

Like the Basic TDFs, Composite TDFs are read from the data stream—however, they can also be obtained from other sources. In addition, some correlation and statistical analysis may be needed before Composite TDFs can be determined. For example, in one embodiment of the present invention, an organization's network is typically very busy at certain periods of a day (during working hours) and not busy at all at other times (from midnight till dawn). During non-peak hours, it is very unlikely that the organization's servers will be accessed. If busy traffic is suddenly directed at the servers at this time, it could mean that an attack is happening. Thus, the servers' thresholds should be lowered. Accordingly, the time of the day is a candidate as a Composite TDF in such an embodiment. Unlike a Basic TDF, however, some monitoring generally occurs before the Learning System can establish which parts of the day are peak, and which are non-peak. Such Threshold Determination Factors are characterized as Composite Threshold Determination Factors, since they cannot be directly read from the data stream like Basic TDFs.

The following is a list of Composite Threshold Determination Factors that may be used in various embodiments of the present invention. The list is not exhaustive. Possible Composite Threshold Determination Factors include, but are not limited to:

Role of a Node: Server, Workstation, or Both?

The Learning System can determine whether a node is acting as a server or workstation or both, by monitoring its data stream over a period of time. On average, a workstation would initiate a lot of connections but not receive connections. In contrast, a server would receive a lot of connections but not initiate connections. A node acting as both would have mixed connections. There are exceptions to these assumptions. In one embodiment, the Learning System calculates an m:n ratio for each node, where m is the number of connections initiated by the node, and n is the total number of connections of the node. If the m:n ratio is high (close to 1), the node is most likely a workstation. If the m:n ratio is low (close to 0), the node is most likely a server. Nodes with m:n ratios hovering in the middle (around 0.5) are probably nodes acting as both servers and workstations. This is one scheme that may be used to determine the role of a node. Other schemes can be used as well. For example, the following threshold determination schemes may be utilized by embodiments of the present invention:

Threshold Determination Scheme 1:

Thresholds for workstations are high;

Thresholds for servers are medium;

Thresholds for nodes that are both server and workstation are low.

Rationale for scheme 1: Servers are more critical than workstations, therefore they should be given lower thresholds to reduce the amount of damage should they be attacked. A node operating as both server and workstation is even more susceptible to attack, so its threshold should be low.

Threshold Determination Scheme 2:

Thresholds for workstations are low;

Thresholds for servers are medium;

Thresholds for nodes that are both server and workstation are low.

Rationale for scheme 2: This scheme may be applicable for an organization in which the servers are tightly guarded and secured, but the workstations are less guarded. This is relevant when there are a great number of workstations and no effective way to have them patched regularly, thus making them susceptible to threats, such as email viruses.

Aggregated Internet-Scale Threat Level Indicator.

There are a number of Internet sites that monitor threats all over the Internet and provide a threat level indicator, which roughly shows the current Internet-scale threat level conditions. Such sites include Internet Storm Center and dshield.org, as well as commercial Internet monitoring organizations. When there is an Internet-scale attack, such as a virulent worm attack, these sites provide a high threat level indicator; at other times, the threat level indicator is low or normal. The threat level indicators from these sites may be aggregated by an embodiment of the present invention and used as a Composite TDF. This is an example of a Composite TDF that is read from external sources rather than the data stream.

Threshold determination scheme: When the aggregated Internet-scale threat level indicator is high, the thresholds of the nodes should be lowered.

Rationale: When a lot of Internet-scale attacks are happening, an organization is more likely to be attacked. Therefore, the thresholds of their nodes should be lowered.

Effect of Time of Day.

The effect of the time of day is discussed briefly above.

Threshold determination scheme 1: In one embodiment, during off-peak periods, the thresholds should be lowered. During peak periods, the thresholds should be higher.

Rationale for scheme 1: Busy traffic during off-peak hours could be a sign that an attack is happening (since no one is supposed to be using the system at that time). Therefore, the thresholds should be lowered.

Threshold determination scheme 2: In another embodiment, during off-peak periods, thresholds are higher, while during peak periods, thresholds are lower. Rationale for scheme 2: This could be used in scenarios where an administrator is concerned about stealthy attacks that attempt to mask themselves by sneaking through the network during peak periods. However, using this scheme could have the adverse effect of a low-threshold node being inaccessible even by legitimate traffic (e.g., if the legitimate traffic was wrongly interpreted as malicious traffic).

Amount of Past Attacks Directed at this Particular Node.

If many attacks are directed at a particular node, it implies that that node is a frequent target of attackers.

Threshold determination scheme: If many past attacks have been directed at a particular node, the threshold of that node should be lowered.

Rationale: Frequent past attacks could be a sign that more attacks are to come. Therefore, a node with a history of many past attack attempts may be lowered to make it more tolerant to such attacks.

Frequency Confidence Levels of Basic TDFs.

The frequency confidence level of basic TDFs estimates how confident the Learning System is about the assessment of a node by measuring its frequency. Based on this confidence, the Learning System can then determine a threshold for the node. To do this, the Learning System measures how frequent certain Basic TDFs appear in the data stream for a particular node. For example, one embodiment utilizes the type of services running on the node. If the Learning System observes HTTP services frequently, then the node is likely to be running a HTTP service, so our confidence in it being a HTTP server is higher. However, if the Learning System observes FTP services only sporadically, the Learning System is less confident that the node is an FTP server. The frequency of the Basic TDFs is measured in relation to time. Various schemes may be utilized.

Threshold determination scheme: The less confident the Learning System is about the Basic TDFs, the lower the threshold would be for that node in which the Basic TDFs are associated with.

Rationale: When the Learning System is not confident about an assessment of the node, it takes a conservative approach and lowers the threshold so that that node is better protected against attacks.

Reference Confidence Level of Basic TDFs.

In one embodiment, Basic TDFs are compared to Reference Databases if those Reference Databases are available for the particular Basic TDF. The Reference Databases record likely associations between Basic TDFs—for instance, a Sendmail mail server may more likely be used with a Linux server, then it would be with Windows. Therefore, a Sendmail-Linux association is stronger than a Sendmail-Windows association. If the Learning System detects a Sendmail server that is running on a Windows machine, its confidence that it has assessed that node correctly is lower. Like the frequency confidence levels, if the reference confidence levels are low, that implies that the Learning System may not have assessed the node correctly.

Threshold determination scheme: The less confident the Learning System is about the Basic TDFs, the lower the threshold would be for that node in which the Basic TDFs are associated with.

Rationale: When the Learning System is not confident about the assessment of the node, we should take the conservative approach and lower the threshold so that that node is better protected against attacks.

The frequency and reference confidence levels are calculated by a confidence level function. The function returns a value on the confidence level scale shown in FIG. 10. For example, the confidence level function might return a value like 2, which according to the scale, means that the association of the Basic TDF to this node is unlikely.

Different functions could be used for different kinds of Composite TDFs and Basic TDFs. The output of these functions may then be used to calculate the threshold of the nodes. For instance, in one embodiment, this is done by matching the function output to a set of modifiers that are defined in the Environment Profile. To facilitate this matching process, each confidence level function could be assigned a function ID.

### Management Threshold Determination Factors

Unlike the Basic and Composite TDFs, Management TDFs are statically defined by either the administrator or by the system default values. In one embodiment, Management TDFs are obtained from the configuration file and the Environment Profile.

The Management TDFs are used in conjunction with the Basic and Composite TDFs to calculate the final node threshold. In one embodiment of the present invention, all of the following Management TDFs are defined in the Environment Profile, with the exception of the first one—overall sensitivity is defined in the configuration file. The objective of the modifiers is to provide a mechanism to increase or decrease the node threshold based on the Basic and Composite TDFs. The Basic and Composite TDFs tend to be categorical or they are part of a scale consisting of a small number of values. The modifiers allow these categories and scale values to be converted into a positive/negative value, which can then be used to increase or decrease the node threshold respectively.

In one embodiment of the present invention, the Management Threshold Determination Factors listed below are utilized. This list is not exhaustive. Possible Management Threshold Determination Factors include, but are not limited to:

Overall Sensitivity.

The overall sensitivity is defined in the configuration file. It is categorical in nature and can be one of three values: conservative, moderate, or aggressive. An aggressive sensitivity would lower the node threshold much more than a conservative sensitivity.

Initial Threshold for a New Node.

The initial threshold for a new node is defined in the environment profile. It is the actual numeric value that would be used as the threshold for a new node before any adjustments are made.

Threshold Modifier for Each Risk Level.

The threshold modifier has already been briefly discussed in Section 8.6.1. The risk level scale (FIG. 10) is used to represent risk. When a risk level is assigned to a Basic TDF, it shows how risky that TDF is (from a scale of 1 to 5). The threshold modifier is used to convert this risk level into a modifier, which can then be used to increase or decrease the node threshold. A higher risk level would have a modifier that decreases the node threshold by a more significant degree.

Modifier for Overall Sensitivity.

This is a modifier that is used to increase or decrease the node threshold based on the overall sensitivity. An aggressive sensitivity would have a modifier that decreases the node threshold by a more significant degree.

Modifier for Node Role.

This is a modifier that is used to adjust the node threshold based on the role of a node (is it a server or workstation or both?). Whether the modifier is positive or negative depends on the scheme being used.

Modifier for Current Operation Mode.

The current operation mode that is relevant to this case is whether the Learning System is in the LEARNING or ESTABLISHED operation mode. A possible scheme that could be used would have the modifier for the LEARNING mode to carry a negative value, while the modifier for the ESTABLISHED mode would be zero.

Modifier for Confidence Levels.

As mentioned earlier, if the Learning System is not very confident about the node being assessed, it would recommend lower thresholds for the nodes. Therefore, the modifier for the lower end of the confidence level scale (least confident) would have a larger negative value, compared to the modifier for the higher end of the scale.

Calculation of Node Threshold

In one embodiment of the present invention, the Learning System calculates the threshold of a node using the Threshold Determination Factors discussed above. One embodiment utilizes the following node threshold calculation scheme:

$$Node threshold = Initial threshold of new node op Modifier ( Overall Sensitivity ) op Modifier ( Risk Level for Each Basic TDF ) op Modifier ( Risk Level for Each Composite TDF ) op Modifier ( Aggregated Frequency Confidence Levels ) op Modifier ( Aggregated Reference Confidence Levels ) op Modifier ( Operation Mode )$$

op is an appropriate operator that can be used (e.g., the + operator). The Modifier(x) notation means the modifier for x. For example, Modifier(Overall Sensitivity) means the modifier for the overall sensitivity.

Note that the node thresholds are not static by default—they are calculated periodically, which could be very frequent or less frequent depending on the scheme used.

### Configuration File

In one embodiment of the present invention, the configuration file is used to specify configuration parameters for the Learning System. The configuration file in such an embodiment also specifies other parameters that are specific to the embodiment of the Learning System. For instance, if the Learning System is embodied as a web-enabled appliance, a possible embodiment-specific parameter would be whether Secure Sockets Layer (SSL) is enabled or not.

There are three types of configuration parameters:

Overall sensitivity,

Choice of Environment Profile, and

Choice of Reference Database.

The overall sensitivity in such an embodiment is defined to be conservative, moderate, or aggressive. Depending on the scheme being used, more than three sensitivity levels can be used, and likewise, less than three can be used as well.

The Choice of Environment Profile allows the administrator to select which Environment Profile to use. Different Environment Profiles can be used for specific scenarios.

The Choice of Reference Database lets the administrator choose the set of relevant Reference Databases for the Learning System to use.

If the administrator chooses not to set the configuration parameters, the default configuration parameters are used. In one embodiment, the following default configuration parameters are utilized:

Overall sensitivity: Moderate.

Environment Profile: Generic.

Reference Database: Whichever Reference Database(s) that are relevant to the embodiment of the Learning System.

### Environment Profile

As described above, the environment profile allows embodiments of the Learning System to specify parameters that could be used to influence the calculation of node thresholds in different environments. An environment profile could exist for a small business environment, while another environment profile could be used for a home user. Custom environment profiles are also possible. This table describes what is defined in an environment profile in one embodiment of the present invention:

Meta Information

| | |
|---|---|
| Name | Name of environment profile. |
| Learning System | The minimum version of the Learning System that is |
| version | required to understand the format and fields of this |
| | environment profile. |
| Reference Databases | A list of reference databases that this Environment |
| | Profile understands. |
| Threshold Scheme | The value of this field can be either static or moving. A |
| | static threshold means that the node threshold is fixed at |
| | a certain value by the administrator. A moving threshold |
| | means that the threshold is calculated dynamically by the |
| | procedures discussed in Section 8.6 and 8.7. |
| Initial Threshold | Initial threshold for a new node. |

Modifiers Part 1: Overall sensitivity

| | |
|---|---|
| Conservative | Modifier for conservative sensitivity. |
| Moderate | Modifier for moderate sensitivity. |
| Aggressive | Modifier for aggressive sensitivity. |

Modifiers Part 2: Basic risk levels

| | |
|---|---|
| Basic Risk Level 1 | Modifier for Risk Level 1 (least risky) of the Basic |
| | TDFs. |
| Basic Risk Level 2 | Modifier for Risk Level 2 of the Basic TDFs. |
| Basic Risk Level 3 | Modifier for Risk Level 3 of the Basic TDFs. |
| Basic Risk Level 4 | Modifier for Risk Level 4 of the Basic TDFs. |
| Basic Risk Level 5 | Modifier for Risk Level 5 (most risky) of the Basic |
| | TDFs. |

Modifiers Part 3: Composite risk levels

| | |
|---|---|
| Composite Risk | Modifier for Risk Level 1 (least risky) of the Composite |
| Level 1 | TDFs. |
| Composite Risk | Modifier for Risk Level 2 of the Composite TDFs. |
| Level 2 | |
| Composite Risk | Modifier for Risk Level 3 of the Composite TDFs. |
| Level 3 | |
| Composite Risk | Modifier for Risk Level 4 of the Composite TDFs. |
| Level 4 | |
| Composite Risk | Modifier for Risk Level 5 (most risky) of the Composite |
| Level 5 | TDFs. |

Modifiers Part 4: Confidence

| | |
|---|---|
| Frequency Confidence Level 1 | Modifier for Frequency Confidence |
| (Impossible) | Level 1. |
| Frequency Confidence Level 2 | Modifier for Frequency Confidence |
| (Unlikely) | Level 2. |
| Frequency Confidence Level 3 | Modifier for Frequency Confidence |
| (Neutral) | Level 3. |
| Frequency Confidence Level 4 (Very | Modifier for Frequency Confidence |
| Likely) | Level 4. |
| Frequency Confidence Level 5 | Modifier for Frequency Confidence |
| (Definite) | Level 5. |
| Reference Confidence Level 1 | Modifier for Reference Confidence |
| (Impossible) | Level 1. |
| Reference Confidence Level 2 | Modifier for Reference Confidence |
| (Unlikely) | Level 2. |
| Reference Confidence Level 3 | Modifier for Reference Confidence |
| (Neutral) | Level 3. |
| Reference Confidence Level 4 (Very | Modifier for Reference Confidence |
| Likely) | Level 4. |
| Reference Confidence Level 5 | Modifier for Reference Confidence |
| (Definite) | Level 5. |

Risk Level Determination

| | |
|---|---|
| Role: Server | Risk level to assign if the role of the node is server. |
| Role: Workstation | Risk level to assign if the role of the node is |
| | workstation. |
| Role: Both | Risk level to assign if the node is both a server and a |
| | workstation. |
| Internet Risk Level: 1 | Risk level to assign if the Internet risk level is 1 |
| | (least risky). |
| Internet Risk Level: 2 | Risk level to assign if the Internet risk level is 2. |
| Internet Risk Level: 3 | Risk level to assign if the Internet risk level is 3. |
| Internet Risk Level: 4 | Risk level to assign if the Internet risk level is 4. |
| Internet Risk Level: 5 | Risk level to assign if the Internet risk level is 5 |
| | (most risky). |
| Time of Day: Peak | Risk level to assign when it is peak period during the |
| | day. |
| Time of Day: Off-peak | Risk level to assign when it is off-peak period during |
| | the day. |
| Past Attacks: 81%-100% | Risk level to assign if the percentage of attacks on |
| | this node is 81%-100% of total attacks recorded. |
| Past Attacks: 61%-80% | Risk level to assign if the percentage of attacks on |
| | this node is 61%-80% of total attacks recorded. |
| Past Attacks: 41%-60% | Risk level to assign if the percentage of attacks on |
| | this node is 41%-60% of total attacks recorded. |
| Past Attacks: 21%-40% | Risk level to assign if the percentage of attacks on |
| | this node is 21%-40% of total attacks recorded. |
| Past Attacks: 0%-20% | Risk level to assign if the percentage of attacks on |
| | this node is 0%-20% of total attacks recorded. |

### An Example

The following describes one embodiment of the present invention for performing the node threshold calculation process. In this embodiment, the Learning System is analyzing a Linux server in a small business environment during the peak period. The administrator is confident about the security of the system, so the overall sensitivity level has been set to be Conservative. At this point in time, there is no large-scale attack that affects the entire Internet, so the aggregated Internet-scale threat level is at Risk Level 2. The scheme that the administrator is using for the Learning System uses the OS-App Reference Database (a mapping of operating systems to applications). The following summarizes the environment:

Time of day: Peak

Overall sensitivity: Conservative

Internet threat level: Risk Level 2

Environment Profile: Small Business

Reference Database: OS-App

The server in the embodiment is running the Linux 2.4.22 kernel, which is a fairly current release. The server runs three services: SSH, Telnet, and FTP. During the configuration of the server, the administrator has used the Mozilla web browser to look for information on the Internet. The administrator has also used the Wine program on Linux to run the Windows web browser Internet Explorer on Linux, which is an unlikely combination.

Based on this information, the following table illustrates how the Learning System would analyze Node B. The Risk Levels of the Basic TDFs are determined from the Reference Database. The Risk Levels of Composite TDFs are determined from the Environment Profile. The Frequency Confidence Level is calculated based on a frequency:time scheme over a period of time. The Reference Confidence Level is derived from the Reference Database, based on how strong the specified association is (for example, the Reference Confidence of an SSH-Linux combination is 4 (Very Likely), since the SSH-Linux association is very strong).

| | Risk | | Reference |
|---|---|---|---|
| Node | Level | Freq | Confidence |
| Node B: | | | |
| Basic TDFs | | | |
| Operating system: Linux | 2 | 4 (VL) | |
| Operating system version: 2.4.22 | 3 | 4 (VL) | |
| Number of services: 3 | 3 | | |
| Types of services | | | |
| SSH | 2 | 5 (D) | SSH-Linux: 4 (VL) |
| Telnet | 4 | 3 (N) | Telnet-Linux: 3 (N) |
| FTP | 4 | 2 (U) | FTP-Linux: 3 (N) |
| Applications | | | |
| Mozilla | 2 | 3 (N) | Mozilla-Linux: |
| | | | 4 (VL) |
| Version 0.9.7 | 4 | 3 (N) | |
| Internet Explorer | 5 | 2 (U) | IE-Linux: 2 (U) |
| Version 5.0 | 5 | 2 (U) | |
| Composite TDFs | | | |
| Role: Server | 4 | | |
| Internet-scale threat level: 2 | 2 | | |
| Time of day: Peak | 2 | | |
| Number of past attacks: 1% | 1 | | |

The Environment Profile that is used in this example is one meant for a small business, and is shown in the table below:

Meta Information

| Name | SMALLBIZ |
|---|---|
| Learning System | 1.00 |
| version | |
| Reference Databases | OS-App |
| Threshold Scheme | Moving |
| Initial Threshold | 25 |

Modifiers Part 1: Overall sensitivity

| | |
|---|---|
| Conservative | +10% (Increase the final node threshold by 10%) |
| Moderate | 0% (Leave the final node threshold as it is) |
| Aggressive | −10% (Decrease the final node threshold by 10%) |

Modifiers Part 2: Basic risk levels

| | |
|---|---|
| Basic Risk Level 1 | 0.0 |
| Basic Risk Level 2 | −0.2 |
| Basic Risk Level 3 | −0.4 |
| Basic Risk Level 4 | −0.7 |
| Basic Risk Level 5 | −1.0 |

Modifiers Part 3: Composite risk levels

| | |
|---|---|
| Composite Risk Level 1 | 0.0 |
| Composite Risk Level 2 | −0.2 |
| Composite Risk Level 3 | −0.4 |
| Composite Risk Level 4 | −0.7 |
| Composite Risk Level 5 | −1.0 |

Modifiers Part 4: Confidence

| | |
|---|---|
| Frequency Confidence Level 1 (Impossible) | −0.5 |
| Frequency Confidence Level 2 (Unlikely) | −0.3 |
| Frequency Confidence Level 3 (Neutral) | −0.1 |
| Frequency Confidence Level 4 (Very Likely) | +0.1 |
| Frequency Confidence Level 5 (Definite) | +0.3 |
| Reference Confidence Level 1 (Impossible) | −0.5 |
| Reference Confidence Level 2 (Unlikely) | −0.3 |
| Reference Confidence Level 3 (Neutral) | −0.1 |
| Reference Confidence Level 4 (Very Likely) | +0.1 |
| Reference Confidence Level 5 (Definite) | +0.3 |

Risk Level Determination

| | |
|---|---|
| Role: Server | 4 |
| Role: Workstation | 2 |
| Role: Both | 4 |
| Internet Risk Level: 1 | 1 |
| Internet Risk Level: 2 | 2 |
| Internet Risk Level: 3 | 3 |
| Internet Risk Level: 4 | 4 |
| Internet Risk Level: 5 | 5 |
| Time of Day: Peak | 2 |
| Time of Day: Off-peak | 4 |
| Past Attacks: 81%-100% | 5 |
| Past Attacks: 61%-80% | 4 |
| Past Attacks: 41%-60% | 3 |
| Past Attacks: 21%-40% | 2 |
| Past Attacks: 0%-20% | 1 |

Using the SMALLBIZ Environment Profile, the Learning System will calculate the node threshold as follows:

| | | Current |
|---|---|---|
| | | Threshold |
| Current Evaluation | Modifier | Value |
| Initial Threshold | | 25 |
| Basic TDF: Operating System: Linux | | |
| Basic Risk Level = 2 | −0.2 | 24.8 |
| Frequency Confidence Level = 4 | +0.1 | 24.9 |
| (VL) | | |
| Basic TDF: OS Version: Linux 2.4.22 | | |
| Basic Risk Level = 3 | −0.4 | 24.5 |
| Frequency Confidence Level = 4 | +0.1 | 24.6 |
| (VL) | | |
| Basic TDF: Number of services = 3 | | |
| Basic Risk Level = 3 | −0.4 | 24.2 |
| Basic TDF: Type of service: SSH | | |
| Basic Risk Level = 2 | −0.2 | 24.0 |
| Frequency Confidence Level = 5 | +0.3 | 24.3 |
| (D) | | |
| Ref Conf (SSH-Linux) = 4 (VL) | +0.1 | 24.4 |
| Basic TDF: Type of service: Telnet | | |
| Basic Risk Level = 4 | −0.7 | 23.7 |
| Frequency Confidence Level = 3 | −0.1 | 23.6 |
| (N) | | |
| Ref Conf (Telnet-Linux) = 3 (N) | −0.1 | 23.5 |
| Basic TDF: Type of service: FTP | | |
| Basic Risk Level = 4 | −1.0 | 22.5 |
| Frequency Confidence Level = 2 | −0.3 | 22.2 |
| (U) | | |
| Ref Conf (FTP-Linux) = 3 (N) | −0.1 | 22.1 |
| Basic TDF: App: Mozilla | | |
| Basic Risk Level = 2 | −0.2 | 21.9 |
| Frequency Confidence Level = 3 | −0.1 | 21.8 |
| (N) | | |
| Ref Conf (Mozilla-Linux) = 4 (VL) | +0.1 | 21.9 |
| Basic TDF: App Version: Mozilla 0.9.7 | | |
| Basic Risk Level = 4 | −0.7 | 21.2 |
| Frequency Confidence Level = 3 | −0.1 | 21.1 |
| (N) | | |
| Basic TDF: App Version: Internet Explorer | | |
| Basic Risk Level = 5 | −1.0 | 20.1 |
| Frequency Confidence Level = 2 | −0.3 | 19.8 |
| (U) | | |
| Ref Conf (IE-Linux) = 2 (U) | −0.3 | 19.5 |
| Basic TDF: App Version: Internet Explorer | | |
| 5.0 | | |
| Basic Risk Level = 5 | −1.0 | 18.5 |
| Frequency Confidence Level = 2 | −0.3 | 18.2 |
| (U) | | |
| Composite TDF: Role: Server | | |
| Composite Risk Level = 4 | −0.7 | 17.5 |
| Composite TDF: Internet threat level: 2 | | |
| Composite Risk Level = 2 | −0.2 | 17.3 |
| Composite TDF: Time of day: Peak | | |
| Composite Risk Level = 2 | −0.2 | 17.1 |
| Composite TDF: Past Attacks: 1% | | |
| Composite Risk Level = 1 | 0.0 | |
| Overall Sensitivity Adjustment | *1.1 | 18.8 |
| (Conservative) | | |
| Final Node Threshold | | 18.8 |

So, the threshold for this node is 18.8. Note that in the embodiment shown, the overall sensitivity (Conservative in this case) is applied to the node threshold right at the very end of the calculations.

### State

In one embodiment of the present invention, state information, for the purposes of the Learning System, consists of four different pieces of information:

Time Counter—records current time and accumulated uptime of the Learning System.

System-Level Statistics—records high-level statistics that have been gathered

Real-Time State—records real-time state.

Node State—records information about each individual node, such as the Basic TDFs and Composite TDFs.

### Time Counter

The Time Counter is used to record up-to-date time-related information for the Learning System to use. It may be used to calculate the Frequency Confidence Levels for the various Basic TDFs. The Time Counter may include, for example, the following:

Time first started;

Accumulated uptime since first start T;

Time first started for current session S(C);

Uptime for current session E(C)-S(C);

Number of DUMP_STATE operations in current session; and

Number of DUMP_STATE operations since first startup.

### System-Level Statistics

System-Level Statistics are high-level statistics that are collected from the data stream over time. These statistics may include, for example:

Total number of connections;

Total bandwidth; and

Total number of attacks.

The system-level statistics may be used to calculate certain Composite TDFs, such as the percentage of past attacks directed at a particular node (this can be very easily done: Total Attacks Directed at Node/Total Number of Attacks). Other statistics for individual nodes can be calculated in a similar manner.

8.11.3 Real-Time State
Real-time state represents up-to-the-minute information that is used by the Learning System. The real-time state influences the way node thresholds are calculated. Real-time state consists of two Composite TDFs—Internet-scale threat level and time of day. These two Composite TDFs allow the node thresholds to be tuned accordingly (a high Internet-scale threat level lowers node thresholds; off-peak hours also lower node thresholds).
Threshold Determination Factors are stored in the following format:
   TDF Name: the name of the TDF.
   TDF ID: a unique ID that identifies this TDF.
   TDF Type: is this a Basic, Composite, or Management TDF?
   Value: the possible number of values that can be assigned to this TDF.
   Risk Level: the risk level of this TDF.
   TDF-specific data: this is a data structure that is specific to this TDF. Having this data structure would facilitate the introduction of new TDFs, since data that is specific to the new TDF would be kept to this structure, but the other fields (as mentioned above) can be retained where they are. For example, for the TDF-specific data for the Internet-scale threat level would be the individual threat levels of each Internet monitoring organization.
Real-time State consists of the following Composite TDFs:
   Internet-scale Threat Level
      TDF Name: Internet-scale Threat Level
      TDF ID: CTDF0001
      TDF Type: Composite
      Value: The current Internet threat level or “unavailable” or “unused”
      Risk Level: the current risk level of this Composite TDF as determined by the Environment Profile.
      TDF-specific data: The individual threat levels of each Internet monitoring organization
   Time of Day
      TDF Name: Time of Day
      TDF ID: CTDF0002
      TDF Type: Composite
      Value: Peak or Off-peak or “unavailable” or “unused”
      Risk Level: the current risk level of this Composite TDF as determined by the Environment Profile.
      TDF-specific data: the periods of time that are considered peak period and the periods of time that are off-peak.

### Node State

The Node State captures the characteristics of a node at a given point in time. It consists of seven parts: Node ID, Identification, Threshold, Context-Specific information, Node-Level Statistics, Basic TDFs, and Composite TDFs.
Node ID: This is a unique ID that the Learning System uses to identify nodes.
Identification: The Identification section has fields that are specific to the context in which the Learning System is used. For example, if the Learning System is deployed in a TCP/IP network, the fields in the Identification section would be IP address and MAC address. Other context-specific unique (or reasonably unique) identifiers can also be used as part of Identification fields.
Threshold: This is the current node threshold that is calculated from the TDFs, as described in Section 8.10.
Context-Specific Data: This is a data structure that stores information that is specific to the context in which the Learning System is deployed. For instance, in a TCP/IP network, this data structure would consist of the network's subnet, known DNS servers, DHCP server, etc. These fields are also used by the Response System to identify potential attacks.
Node-Level Statistics
   Number of initiated connections: This is the number of connections initiated by this node. In a TCP/IP network, this would be the number of outgoing SYN packets generated by this node.
   Total number of connections: This field represents the total number of connections that are related to this node.
Basic TDFs: This is a list of Basic TDFs, stored in the TDF format as described above. The basic TDFs are the ones discussed in Section 8.6.1 (operating systems, services, etc.)
Composite TDFs: This is a list of Composite TDFs, stored in the TDF format as described above. For brevity, the following list will only discuss their possible values and what is in the TDF-specific data structure. Currently, the list of Composite TDFs that should be stored in the Node State are:
   Role: Possible values are “Server” or “Workstation” or “Both” or “Unavailable” or “Unused”. TDF-specific data would be the current m:n ratio described in Section 8.6.2.
   Percentage of Past Attacks: Possible values are some percentage or “Unavailable” or “Unused”. TDF-specific data is the current number of attacks directed at this node.

### Reference Confidence Level

In one embodiment of the present invention, the Reference Confidence Level is calculated using Reference Databases. FIG. 9 is a block diagram illustrating a Reference Database in one embodiment of the present invention. The Reference Database in FIG. 9 maps operating systems to their likely services and applications. The “OS” field on the far left of the figure is the actual operating system and version obtained using a fingerprinting process (identifying unique characteristics of a data stream that are only exhibited by a certain operating system). The actual operating system is then mapped to an “OS minor” field, which is basically the operating system without the version. The “OS minor” field is then linked to the “OS major” field, which can be likened to a family of operating systems, which this operating system belongs to.

The “OS major” field is then mapped to various services. Each service has some service-specific information—in FIG. 9, this information includes the name of the service, the port number, and the protocol used by the service. The “confi” field represents the confidence of the mapping between the “OS major” field and the particular service. For example, a UNIX-SSH mapping is very likely (VL), while a UNIX-Kerberos mapping is likely (L). Unknown services are also accounted for—in this case, an unknown TCP service is given the name “uk_tcp”.

Services are also mapped to servers, which represent server software that is likely to be used to provide these services. For example, the WWW service can be provided by the Apache or Zeus web server software.

Applications are also mapped to the “OS major” field. Like services, “OS major”-application mappings also have confidence levels. The descriptions of these applications can be broken down further into major names and minor names. For example, the major name for the Mozilla suite of web browsers is “Mozilla”, while minor names may be “Mozilla”, “Firefox”, and “Galeon” (which are three different web browsers based on the Mozilla HTML rendering engine).

### Frequency Confidence Level Schemes (How the Learning System Uses Time)

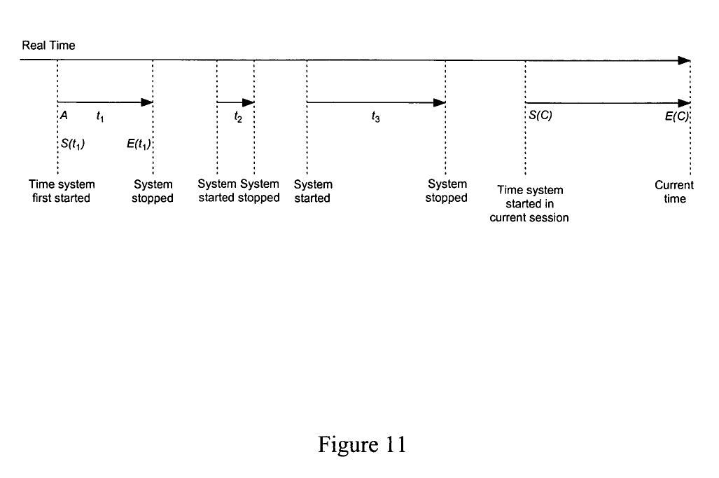

This section describes various schemes that could be used to calculate the Frequency Confidence Level of various Basic TDFs. First of all, it is important to understand the various sessions that the Learning System is in use, and how they relate to actual time. In one embodiment, the Learning System is embodied as an electronic device. In another embodiment, the Learning System is embodied as software running on a computing device. In either of these embodiments, an administrator is allowed to turn the device on and off. A session refers to the period of time when the Learning System is turned on, to the point when it is turned off. Through the lifetime of the device, there may be many sessions as the device is turned on and off at various points (for maintenance, testing, etc.). FIG. 11 is a timing diagram illustrating the process of starting and stopping the Learning System in one embodiment of the present invention.

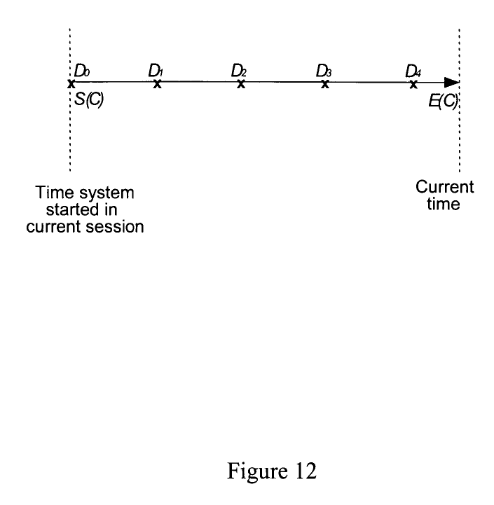

FIG. 12 is a timing diagram illustrating the occurrence of DUMP_STATE operations in one embodiment of the present invention. In the embodiment shown, within a session, there may be multiple DUMP_STATE operations (shown as little x's in FIG. 12). These are the times when the state (described above) is written to the storage medium. Each of these DUMP_STATE points is numbered (D₁, D₂, etc.).

In various embodiments of the present invention, the Learning System perceives and uses time in different ways. For instance, the Learning System may use time:

as a accumulated counter that keeps incrementing in ticks as long as the Learning System is on;

as actual network time derived from its embodiment;

as localized time, which means that the time zone has been taken into account; and/or

as the number of DUMP_STATE operations that have been done.

The notation that may be used by one embodiment of the Learning System is as follows:
A is the first time the Learning System device is ever started.
C refers to the current session.
B(C) is the time that is recorded every time the Learning System device is started.
S(C) is the start time of the current session that is recorded in the state.
E(C) is the time when the last DUMP_STATE operation happened.
tᵢ is the total time for session i. tᵢ is measured in ticks, where a tick may be a minute or second or millisecond, depending on the scheme used.
T is the accumulated uptime for all sessions (Σtᵢ).
Tₚᵣₑᵥ is the accumulated uptime from previous sessions (this means all sessions except the current session).
dump_count keeps track of the number of dumps done since first boot.

S(C) is the start time of the current session. This is recorded in the state during DUMP_STATE. Therefore, if the Learning System reads S(C) from the state, and S(C)=B(C), that means we're still in the current session. If they don't match, that means a reboot of the device has occurred.

One algorithm according to one embodiment of the present invention that may be used to dump the Time Counter into the state is described by the following pseudo code:

Precondition: Upon bootup, B(C) = current time.
dump_counter ( )
{

if No State {

// If there is no state, this is the first time

we're starting the

// Adaptive Security System
FirstBoot = B (C) ;
dump_count = 0 ;
T = 0 ;
Tprev = 0 ;
S(C) = B(C) ;
E(C) = S(C) ;
Write State

} else {

| Read State [ T, Tprev, S(C) , E(C) , dump_count ] ; | |
|---|---|
| if (S(C) == B(C)) { | // The Learning System is |

in the current session

E(C) = current time;
T = Tprev + E(C) − S(C) ;

| | |
|---|---|
| } else { | // A reboot has occurred |

since last dump

Tprev = Tprev + T;
S(C) = B(C) ;
E(C) = S(C) ;

}
Write State;
dump_count++;

}

}

The reason why the accumulated uptime is stored in state periodically and not constantly is because of possible storage medium wear and tear, which is typical with media such as CompactFlash cards (as described above).

### Monitoring Events for Frequency Confidence Levels

One objective of keeping time is to facilitate the monitoring of events (such as Basic TDFs), so that frequency confidence levels can be assigned to those events. Many schemes can be used for this purpose. In embodiments of the present invention, each scheme attempts to incur minimal storage space.

Three time-related parameters may provide information about an event: Actual network time (e.g. “18:49:55”);

Accumulated uptime in ticks; and

Dump number.

In one embodiment, these three parameters are stored in a data structure called a time context. A time context is associated with each event—thus, for each event, we would know when it happened (actual time), when it happened since the first time the Learning System device is started (accumulated uptime), and how many DUMP_STATE operations have happened before this event (dump number).

By comparing the time context of an event with the current time context (current time, current accumulated uptime, and current dump number), the Learning System can estimate how far back an event occurred in relation to current time.

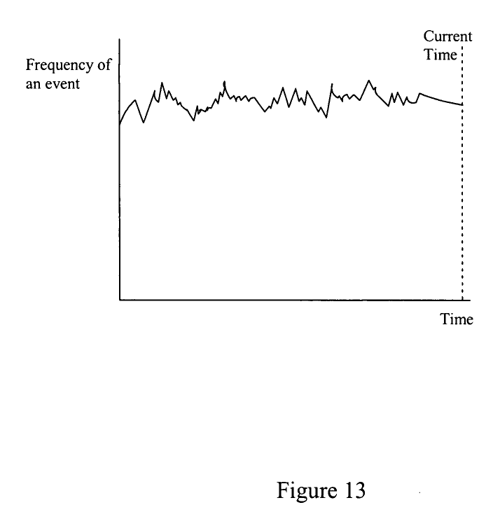

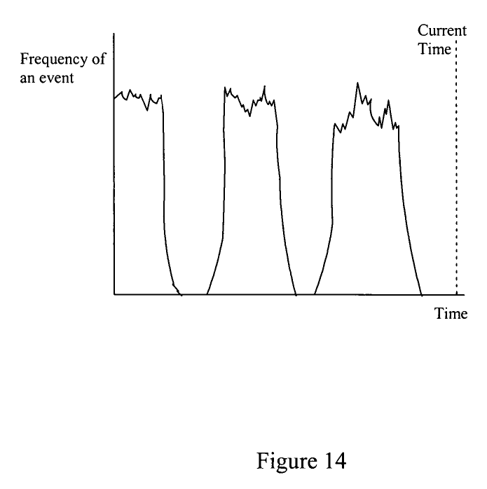

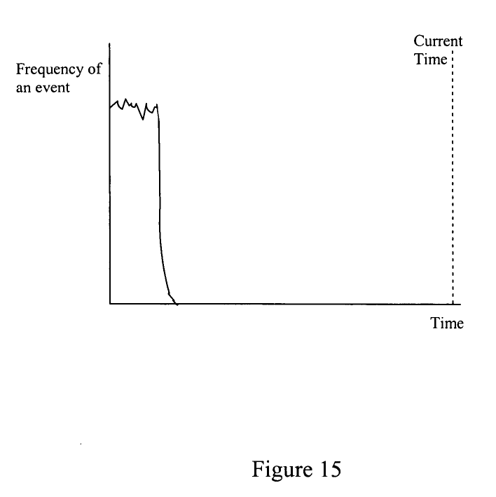

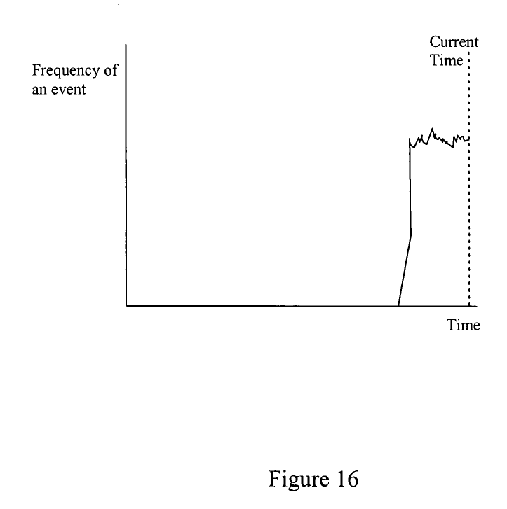

Various scenarios are considered when evaluating time contexts. FIGS. 13, 14, 15, and 16 are graphs illustrating events in relation to time in several embodiments of the present invention. The regularity of the events is different in each scenario.

To be effective, the time scheme utilized by an embodiment of the present invention captures the historical characteristics of an event with minimal storage costs. In one embodiment, the Learning System uses the average number of times an event is seen over the course of time. In another embodiment, the Learning System uses the highest and lowest frequencies of an event. It is also possible to record just the x highest frequencies and y lowest frequencies. Yet another embodiment could gauge the frequency confidence of a scheme by comparing the first time an event was seen with the last time the event was active. Combinations of these schemes are possible and a variety of other schemes can be envisioned by those skilled in the art.

### Updating the Learning System and Reference Databases

From time to time, embodiments of the present invention may need to be updated. For instance, the binary programs that run Adaptive Security System, as well as the Reference Databases and Environment Profiles, may need to be updated. The reasons for these are manifold. New versions of the binary programs, featuring better algorithms, bug fixes, and engine improvements, could be available. More up-to-date Reference Databases may available—if current Reference Databases are updated with these new Reference Databases, they would be able to better reflect current situations. For instance, the OS-App Reference Database could be updated to accommodate the latest versions of operating systems, applications, and so forth. Likewise, an update to the Environment Profile may be recommended if there is a new Environment Profile that can better capture the characteristics of a specific environment (better modifiers, more accurate initial node thresholds, etc.). An update is also needed if the Adaptive Security System is transferred to a different environment, thus requiring a new Environment Profile. These updates would allow more accurate calculations of node thresholds, and also allow both the Learning System and Response System to function more effectively.

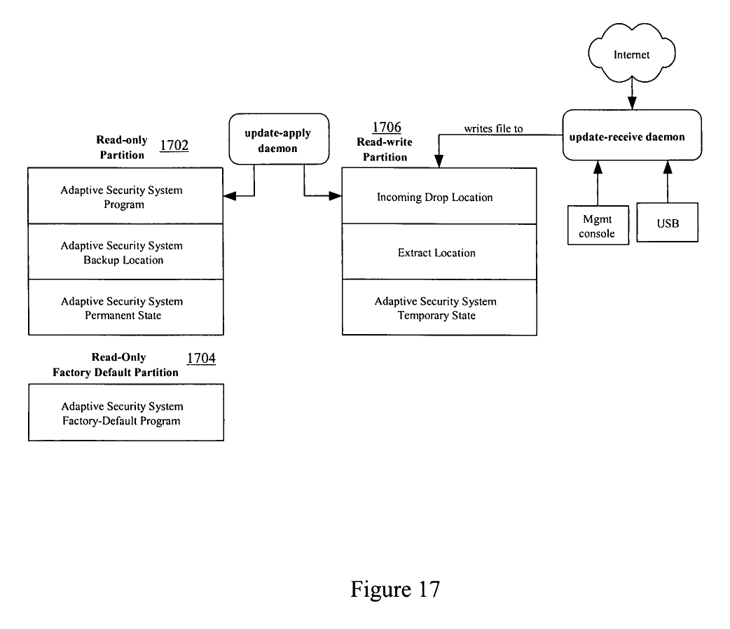

FIG. 17 is a block diagram illustrating a configuration that allows the Adaptive Security System binary programs to be updated in one embodiment of the present invention. For brevity, the diagram is shown only in the perspective of the Adaptive Security System—however, the same configuration and the update techniques could be applied to the Reference Database and Environment Profile as well.

In the embodiment shown, three partitions are illustrated—one read-only partition 1702 (where the current Adaptive Security System program is stored), one read-only “factory default” partition 1704 (where the original Adaptive Security System program that came with the device is stored), and a read-write partition 1706. The read-write partition 1706 could be a temporary memory-based file system, where its contents would be erased when the Adaptive Security System is restarted.

Note that in the embodiment shown in FIG. 17, the locations of the permanent state and the temporary state are illustrated. The permanent state, which a DUMP_STATE operation writes to, is stored in the read-only partition. The DUMP_STATE_TEMP operation dumps state to the read-write partition.

The embodiment shown includes two “daemons” that are used for updates. Daemons are programs that run in the background, waiting to receive an input. Once input arrives, the daemon performs some computation on the input before reverting back to waiting again. Daemons tend to run for an entire session (the time when the Adaptive Security System is started, till the time it is stopped).

The two daemons are the update-receive daemon and the update-apply daemon. The update-receive daemon is capable of receiving an update from an external source (such as the Internet), a physical interface (such as a USB port), or a management console (such as a computer attached to the Adaptive Security System via a serial interface). For the purposes of our discussion, the update here can refer to either the binary programs of the Adaptive Security System, set of Reference Databases, or set of Environment Profiles. Once the update is received, the update-receive daemon writes the file to an Incoming Drop Location in the read-write partition. The update-receive daemon then returns to its waiting cycle.

The update process is carried on by the update-apply daemon from this point forward. The update-apply daemon scans the Incoming Drop Location periodically for new updates. Once an update appears (when the update-receive daemon writes a new update to that location), the update-apply daemon would proceed to extract or unpack it to the Extract Location in the read-write partition. Extracting or unpacking is required, since an update may be stored in compressed form, or may consist of many files, or may be a set of files stored in compressed form.

After extraction, the update-apply daemon performs integrity checks to ensure that the update is valid (various integrity checking schemes could be used, from checking the message digest of the update, to verifying a digital signature of the update, to examining the contents of a file inside the update). Checks also need to be done in order to ensure that the version of the Adaptive Security System in use supports the update, and vice versa. If it passes the integrity checks, the actual Adaptive Security System binary program in the read-only partition can now be replaced with the new version in the Extract Location.

### Applying the Update

This section describes how an update is actually applied in one embodiment of the present invention. These are the steps that are used to apply an update:
Reconfigure the read-only partition to be read-write (this is only done temporarily).
Copy the new version of the update to the Backup Location.
Force a DUMP_STATE operation.
Terminate the current Adaptive Security System programs if it is running.
Replace Adaptive Security System program with the new Adaptive Security System program in the Extract Location.
Start the Adaptive Security System program.
Check if the new Adaptive Security System program is running normally. If not, invoke the failsafe shutdown procedure (shown below).
If it is running normally, reconfigure the read-only partition back to read-only.
Write to a log file (if available) indicating that the update was successful.
Erase the update file(s) from the temporary Incoming Drop Location.
Erase the Adaptive Security System program from the temporary Extract Location.

Note that a failsafe shutdown procedure is referred to in the previous list of steps above. The failsafe shutdown procedure in such an embodiment comprises the following steps:
Terminate the currently running Adaptive Security System program (if it, or any its components, is still running).
Restore the original Adaptive Security System program from the Backup Location by copying it back to the Program location.
Start the Adaptive Security System program.
Erase the update in the temporary Incoming Location.
Erase the Adaptive Security System program in the temporary Extract Location.
Write to a log indicating that the update was unsuccessful
Reconfigure the read-only partition back to read-only.
Exit the update application process.

### Restoring Factory Defaults

In one embodiment, the following steps are used to restore the Adaptive Security System back to its original, “factory default” configuration:
Terminate the current Adaptive Security System program
Erase the Temporary State
Clear the Incoming Drop Location
Clear the Extract Location
Reconfigure the read-only partition as read-write
Erase the Permanent State
Erase any configuration files
Replace Adaptive Security System program with the program in the Factory Default Location
Reconfigure the read-only partition back to read-only

### Receiving the Update

In some embodiments of the present invention, an update can be received from an external source like the Internet, from a physical interface like a USB port, or from a management console. These updates may be received in a variety of ways. For example, embodiments of the present invention may use the four schemes described below.

Scheme 1: Receiving the update from an external source using a non-existent internal node address. In this scheme, the Adaptive Security System assumes a non-existent internal node address, so that it can connect to an external source to receive updates. This may be used, for example, in situations where the Adaptive Security System itself does not have a node address (since it could be integrated into any environment without prior configuration).

To assume a non-existent address, there are two pre-conditions:
The Adaptive Security System has to preferably be in the ESTABLISHED operation mode (although this is not mandatory), so that it would be confident about which node addresses exist, and which don't.
The Adaptive Security System knows whether some form of automatic address configuration device is being used (in the network domain, one example of such a device would be a DHCP server).

This scheme is suitable when the Adaptive Security System is used in these Operational Profiles—OP1: Inter-department (FIG. 2) and OP2: Typical configuration (FIG. 3). The steps to receive updates using this scheme are:
Assume a non-existing node address on the ext_intf interface. This can be done in two ways: if an automatic address configuration device is in use, the Adaptive Security System could request an address from that device. The second way is to simply assign a node address that is known to be unavailable to the ext_intf interface.
Connect to an update repository in the external source (such as a server on the Internet).
Retrieve the latest relevant updates according to an established update retrieval protocol.
Remove the node address from the ext_intf interface.
Apply the update according to the steps outlined above.

Note that if an automatic address configuration device is used in the environment, this scheme may also need to know if the device disables forwarding of data streams without querying it first, and adapt accordingly.

Receiving the update from an external source using an existing internal node address. This scheme also retrieves updates from an external source, but the ext_intf interface assumes an existing internal node address instead of a non-existent one. The pre-condition of this scheme is that the Adaptive Security System should preferably be in the ESTABLISHED operation mode (although this is not mandatory), so that it knows the existing internal node addresses and the services that each node runs. This scheme is suitable for three operational profiles—OP1: Inter-department, OP2: Typical configuration, and OP3: Single node. The steps that are used to implement this scheme are as follows:
Decide on an existing node address and a non-existing service number to connect to the external source. In the network domain, the service number could be a port number.
Set up the data stream blocking policy on the Response System such that it does not forward incoming connections from the update repository to the internal protected node with the existing node address and non-existing service number that have been decided.
Initiated a connection to the update repository using the existing node address and the non-existing service number.
When the update repository replies, the Adaptive Security System responds as though it is the internal node with the address decided earlier. Since the Response System has a no-forward policy for this node and the service number in place, the real internal node does not see this communication at all.
The Adaptive Security System continues acting like the internal node and communicates with an established update retrieval protocol, and retrieves the update by reading the contents of the data stream from the update repository.
After the update is retrieved, the no-forward policy is removed from the Response System.
Apply the update according to the steps outlined in Section above.

Receiving the update from the management console. This scheme is suitable for the operational profiles OP1: Inter-department, OP2: Typical configuration, and OP3: Single node. The steps are described as follows:
The management console is attached to intf( ) (the management interface).
Using the management console, the administrator stops the Adaptive Security System.
The node address of the ext_intf interface is recorded (if there is an address assigned to it in the first place).
The ext_intf interface is given the address of an existing internal node address.
The update is retrieved from the update repository in the external source.
The Adaptive Security System is updated as per the procedures described above.
The node address of the ext_intf interface is changed back to its original address that was recorded earlier.
The administrator disconnects the management console from the system.

Receiving the update from the physical interface. This scheme uses a physical token (such as a USB flash drive) that is inserted into a physical interface (such as a USB port) to update the Adaptive Security System. A physical interface-monitoring daemon is used in this scheme. This scheme is suitable for the operational profiles OP1: Inter-department, OP2: Typical configuration, and OP3: Single node. The steps are described as follows:
The physical interface-monitoring daemon waits for input on the physical interface.
When a physical token containing the update is inserted into the physical interface, the daemon engages itself logically to the token so that it can access contents of the token (the layout of the token must be in a form that is understandable by the daemon).
The daemon copies the update from the token into the Incoming Drop Location of the read-only partition.
The daemon disengages itself from the physical token. At this point, the token can be removed from the physical interface, either programmatically or physically.
The update in the Incoming Drop Location is applied as per the steps described above.

Embodiments of the present invention may be utilized in a variety of application. For instance, one embodiment is utilized for detecting and suppressing general network intrusions. Another embodiment is used for detecting and suppressing specific network intrusions. Yet another embodiment is utilized for detecting and suppressing host-based intrusions. And a further embodiment is utilized for detecting and suppressing insider threats (abuse of electronic resources by malicious insiders). Due to the multi-source nature of the system, it is adaptable to many other domains, and can be applied to other areas by those skilled in the art.

### An Illustrative Network Security System

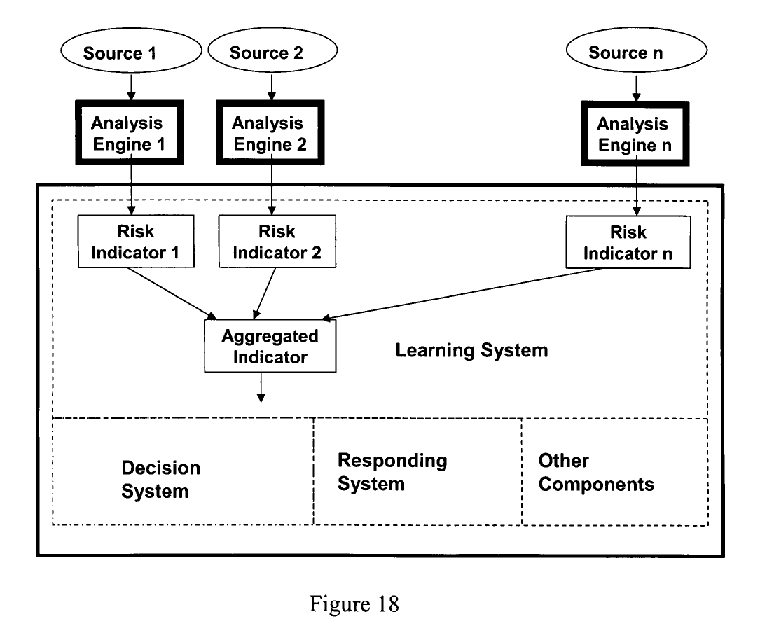

One embodiment of the presenting invention is a network security system employing the Learning System. An adaptive security system employing the Learning System can be viewed as being composed of a multiple number of “attack analysis engines (AAEs)”, together with a central or distributed learning, decision and response making unit. FIG. 18 is a block diagram of an adaptive security system in one embodiment of the present invention.

In the embodiment shown, each attack analysis engine dedicates itself to a specific task. These tasks may include but are not limited to monitoring a network connection, inspecting packets in a data stream, examining incoming/outgoing email messages for virus, spyware and other types of malware, examining the content of an incoming/outgoing network traffic for violation of an organization's policy (such as content filtering), examining the content of an incoming/outgoing network traffic for electronic fraud (such as phishing), dynamically adjusting the bandwidth available to a node or nodes, monitoring the alert level of a local network, a wide area network, or the global Internet for network attacks and so on. A relatively independent software package, such as an intrusion detection/prevention system or a virus scanning utility, may also be employed as an attack analysis engine. Exactly what and how many attack analysis engines are employed in a deployed security system may vary, determined by such factors as cost, data throughput requirements, environment or user profiles etc.

In the embodiment shown, associated with each attack analysis engine is a risk level indicator that suggests the level or intensity of attacks against a security target. How the risk indicator changes its value is determined by the Learning System. As soon as the risk indicator surpasses an assigned threshold, appropriate actions will be taken by the central unit (e.g., the Response System) in response to a potential or current attack.

In such an embodiment, some or all the available risk level indicators may be combined to obtain an “aggregated risk level indicator,” which may be in turn used by the security system to adaptively change its behavior in order to achieve the ultimate goal of better protecting intended system assets.

The aggregated risk level indicator may be computed from risk level indicators associated with the attack analysis engines (called component risk level indicators) using a mathematically sound formula. An example of such formulae is the weighted sum of values of the component risk level indicators. The weights assigned to component risk level indicators may be static over an extended period of time, or vary as determined by such factors as the significance/vulnerability of associated data sources. A more complex formula may involve a non-linear mathematical equation that is determined to be optimal for intended applications. The aggregated risk level indicator may be updated periodically.

As the aggregated risk level indicator suggests the overall level of risks in real time, it can be used in a variety of ways to dynamically protect security targets against attacks. As an example, when the aggregated risk indicator grows beyond an allowed threshold, component risk level indicators of most importance may be lowered by a value derived from the aggregated indicator together with other factors, whereby elevating the level of alertness associated with these component indicators.

As yet another example, when the aggregated risk indicator, although still below the assigned threshold, increases its value as an accelerated speed, component risk indicators may be preemptively adjusted to anticipate a potential attack.

### Potential Applications

Embodiments of the present invention may be utilized in a variety of potential applications. For instance, an embodiment of the present invention may be especially useful for providing adaptive security to large enterprises. Large enterprises often have large and complex computer networks. The Learning System eases the burden of the network administrator since it can automatically learn these complex networks, and it requires little to no manual human configuration.

Embodiments of the present invention may also be successfully deployed in small businesses. Small business owners tend not to have expertise in network security. The Learning System is able to learn the characteristics of the small business's computer network, thus relieving the owner from having to learn network security (or employing someone to do so), and reduce the chances of misconfiguration of a security device due to lack of expertise.

Home users may utilize further embodiments of the present invention. Like small business owners, home users may not have the necessary network security expertise to secure their home computers and home networks. As more and more home users start to use broadband services (according to a recent Internet research survey, 2 in 5 home users in America are now using broadband), the security of these home computers and networks are even more critical. The Learning System eases the burden of the home user from having to learn network security.

Business travelers may also utilize embodiments of the present invention. A business traveler tends to use a portable computer in different network environments throughout business trips. Each network environment may have different security threats. The Learning System could be used to learn the specifics of new environments, and the Response System can in turn provide security for the business traveler.

Various types of companies may utilize embodiments of the present invention in products they sell. For instance, firewall companies, intrusion detection companies, companies selling intrusion prevention systems, security companies, network infrastructure companies, IT technical support providers, and Internet Service Providers may utilize embodiments of the present invention as part of their products and services.

### General

The foregoing description of embodiments of the present invention has been presented only for the purpose of illustration and description and is not intended to be exhaustive or to limit the invention to the precise forms disclosed. Numerous modifications and adaptations thereof will be apparent to those skilled in the art without departing from the spirit and scope of the present invention.

That which is claimed:

1. A method for setting an adaptive threshold for a node comprising:
monitoring a data stream associated with the node to identify a characteristic of the node;
monitoring an environmental factor capable of affecting the node; and
determining the adaptive threshold based on at least one of the characteristic or the environmental factor.

2. The method of claim 1, wherein the characteristic comprises one of: an operating system, an application, or a service.

3. The method of claim 1, wherein the environmental factor comprises one of: an Internet-scale threat level, a past attack against the node, or a time of day.

4. The method of claim 1, further comprising:
identifying a communication directed at the node;
determining a risk level associated with the communication;
comparing the risk level to the adaptive threshold; and
responding to the communication based on the comparison between the risk level and the adaptive threshold.

5. The method of claim 4, wherein the communication comprises an event.

6. The method of claim 5, wherein responding to the communication based on the comparison comprises one of: logging the event, terminating the event, sanitizing the event, or blacklisting a source of the communication.

7. The method of claim 6, wherein the communication comprises an attack in a network environment and wherein responding to the communication based on the comparison comprises one of: logging the attack; terminating a connection; or blacklisting an identifier associated with an origin of the attack.

8. The method of claim 6, wherein the communication comprises an email and wherein responding to the communication based on the comparison comprises one of: logging the malicious email, preventing the malicious email from being sent, sanitizing the email, or blacklisting a source of the email.

9. The method of claim 4, wherein determining the risk level comprises determining a basic threshold determination factor.

10. The method of claim 9, wherein the basic threshold determination factor comprises an operating system risk factor.

11. The method of claim 4, wherein determining the risk level comprises determining a composite threshold determination factor.

12. The method of claim 4, wherein determining the risk level comprises determining a management threshold determination factor.

13. The method of claim 4, further comprising multiplying the risk level by a threshold modifier before comparing the risk level to the adaptive threshold.

14. The method of claim 1, wherein the characteristic comprises the number of services running on a node.

15. The method of claim 1, wherein the characteristic comprises a historical measure of risk associated with an operating system, a service, or an application.

16. The method of claim 1, further comprising:
determining a static threshold, and
modifying the adaptive threshold based on the static threshold.

17. The method of claim 1, wherein determining the adaptive threshold comprises determining an aggregated risk level indicator.

18. A method for dynamically assessing a risk associated with network traffic comprising:
identifying a communication directed at the node;
determining a risk level associated with the communication; and
comparing the risk level to the adaptive threshold.

19. The method of claim 18, further comprising responding to the communication based on the comparison between the risk level and an adaptive threshold.

20. The method of claim 18, further comprising determining an origin of a network packet associated with the communication.

21. The method of claim 21, wherein the first characteristic comprises a sequence number.

22. The method of claim 21, wherein the first characteristic comprises at least one of: a source identifier, a source port, a destination identifier, and a destination port.

23. The method of claim 18, further comprising setting an adaptive threshold for the node.

24. The method of claim 23, wherein setting the adaptive threshold for the node comprises:
monitoring a data stream associated with the node to identify a characteristic of the node;
monitoring an environmental factor capable of affecting the node; and
determining the adaptive threshold based on at least one of the characteristic or the environmental factor.

25. The method of claim 24, wherein the characteristic comprises one of: an operating system, an application, or a service.

26. The method of claim 24, wherein the environmental factor comprises one of: an Internet-scale threat level, a past attack against the node, or a time of day.

27. A computer-readable medium comprising program code adapted to execute on a computer processor for setting an adaptive threshold for a node, the computer-readable medium comprising:
program code for monitoring a data stream associated with the node to identify a characteristic of the node;
program code for monitoring an environmental factor capable of affecting the node; and
program code for determining the adaptive threshold based on at least one of the characteristic or the environmental factor.

28. The computer-readable medium of claim 27, further comprising:
program code for identifying a communication directed at the node;
program code for determining a risk level associated with the communication;
program code for comparing the risk level to the adaptive threshold; and
program code for responding to the communication based on the comparison between the risk level and the adaptive threshold.

29. The computer-readable medium of claim 28, wherein program code for responding to the communication based on the comparison comprises program code for one of: logging the event, terminating the event, sanitizing the event, or blacklisting a source of the communication.

30. The computer-readable medium of claim 29, wherein the communication comprises an attack in a network environment and wherein program code for responding to the communication based on the comparison comprises program code for one of: logging the attack; terminating a connection; or blacklisting an identifier associated with an origin of the attack.

31. The computer-readable medium of claim 29, wherein the communication comprises an email and wherein program code for responding to the communication based on the comparison comprises program code for one of: logging the malicious email, preventing the malicious email from being sent, sanitizing the email, or blacklisting a source of the email.

32. The computer-readable medium of claim 28, wherein program code for determining the risk level comprises program code for determining a basic threshold determination factor.

33. The computer-readable medium of claim 28, wherein program code for determining the risk level comprises program code for determining a composite threshold determination factor.

34. The computer-readable medium of claim 28, wherein program code for determining the risk level comprises program code for determining a management threshold determination factor.

35. The computer-readable medium of claim 28, further comprising program code for multiplying the risk level by a threshold modifier before comparing the risk level to the adaptive threshold.

36. The computer-readable medium of claim 27, further comprising:
program code for determining a static threshold, and
program code for modifying the adaptive threshold based on the static threshold.

37. The computer-readable medium of claim 27, wherein program code for determining the adaptive threshold comprises program code for determining an aggregated risk level indicator.

38. A computer-readable medium comprising program code adapted to execute on a computer processor for dynamically assessing a risk associated with network traffic, the computer-readable medium comprising:
program code for identifying a communication directed at the node;
program code for determining a risk level associated with the communication; and
program code for comparing the risk level to the adaptive threshold.

39. The computer-readable medium of claim 38, further comprising program code for responding to the communication based on the comparison between the risk level and an adaptive threshold.

40. The computer-readable medium of claim 38, further comprising program code for determining an origin of a network packet associated with the communication.

41. The computer-readable medium of claim 38, further comprising program code for setting an adaptive threshold for the node.

42. The computer-readable medium of claim 41, wherein program code for setting the adaptive threshold for the node comprises:
program code for monitoring a data stream associated with the node to identify a characteristic of the node;
program code for monitoring an environmental factor capable of affecting the node; and
program code for determining the adaptive threshold based on at least one of the characteristic or the environmental factor.
